(19) United States
(12) Patent Application Publication
(10) Pub. No.: US 2005/0222406 A1
(43) Pub. Date: Oct. 6, 2005

(54) Condensed palatinose in hydrogenated form

(76) Inventors: Alireza Haji Begli, Ramsen (DE); Michael Klingeberg, Grunstadt (DE); Markwart Kunz, Worms (DE); Manfred Vogel, Neuleiningen (DE)

Correspondence Address: OSTROLENK FABER GERB & SOFFEN, 1180 AVENUE OF THE AMERICAS, NEW YORK, NY, 100368403, US

(21) Appl. No.: 10/527,523

(22) PCT Filed: Sep. 2, 2003
(86) PCT No.: PCT/EP03/09725

§ 371 Date: Mar. 10, 2005

(30) Foreign Application Priority Data
Sep. 11, 2002 (DE) 102 42 062.9

(51) Int. Cl. C08B 37/00

(52) U.S. Cl. 536/123; 536/124

(57) ABSTRACT

The present invention relates to processes for preparing condensed Palatinose in hydrogenated form to hydrogenated condensed Palatinose thus prepared, to uses of the same, and to foodstuffs and drugs comprising hydrogenated condensed Palatinose.

The present invention relates to hydrogenated condensed Palatinose, to processes for preparing the same, to uses of the same, and to foodstuffs and drugs comprising hydrogenated condensed Palatinose.

Free radicals are unstable and highly reactive atoms, molecules or residues having unpaired electrons, and are formed continuously in the body by biochemical oxidation-reduction reactions in the presence of oxygen, by phagocytes, contact with environmental toxins, ionizing radiation, UV rays or severe physical strain. Because of their extreme reactivity, free radicals represent a potential threat for healthy cells and their components. Cell components particularly affected are proteins, nucleic acids and polyunsaturated fatty acids in cell membranes.

The cells are protected from the effects of free radicals principally through the antioxidants, which act as radical scavengers. If antioxidants are not present in sufficient amount, the protection possessed by the cells against free radicals is inadequate. Reduced amounts of antioxidants are observed, for example, in the case of diseases such as cancer, diabetes, hypertension, male infertility, rheumatic disorders and chronic inflammatory diseases. Antioxidants also play a large part in detoxification and in the breakdown of xenobiotics with which humankind comes into contact owing to indoor pollution in the domestic sphere or at the workplace or owing to incorrect diet. Examples of known primary endogenous antioxidants include superoxide dismutase (SOD), glutathione peroxidase (GPx), glutathione, catalase, ferritin and coeruloplasmin.

Glutathione (GSH) is a cysteine-containing tripeptide and the most common thiol compound in mammalian cells. GSH is a substrate for the enzymes glutathion S-transferase and GSH peroxidase, which catalyze reactions for the detoxification of xenobiotic compounds and for the oxidation inhibition of reactive oxygen molecules and free radicals. As the substrate of glutathione S-transferase, glutathione is converted by reversible oxidation into the corresponding disulfide GSSG. Glutathione thereby constitutes a buffer system for the redox state of the cell. Glutathione is additionally involved in cysteine transport, in leukotriene and prostaglandin metabolism, in deoxyribonucleotide synthesis, in immune functions and in cell proliferation (Bray and Taylor, Canadian J. Physiol. Pharmacol., 71 (1995) 746-51). The importance of glutathione particularly for the intestinal tract is evident from the massive damage to the intestinal mucosa that is observed in the case of GSH deficiency, as for example following treatment with the GSH-synthesis inhibitor buthionine sulfoximine (Martensson et al., Proc. Natl. Acad. Sci. USA, 87 (1990), 1715-19). The tissue concentration of GSH is regulated by a variety of factors, which include the nutritional state and the food itself. Between tissue GSH concentration, nutrition and oxidative stress, therefore, there is a close relationship.

Glutathione S-transferases (GSTs) form one of the most important detoxification systems of the cells, particularly during phase II of cell division. Detoxification is accomplished by transfer of glutathione to electrophilic components which are formed, for example, during the metabolism of carcinogens. The GST-catalyzed nucleophilic attack of glutathione on electrophilic substrates greatly lessens their reactivity with respect to cellular macromolecules. GSTs are able in this way greatly to lessen the activity of a range of chemical carcinogens. GSTs therefore play an important physiological part in protection against oxidative stress and associated disorders, especially cancer illnesses. All eukaryotes possess a number of cytosolic and membrane-bound glutathione S-transferases (Hayes and Pulford, Critical Reviews in Biochemistry and Molecular Biology, 30 (1995) 445-600). The expression of GST is tissue-specific. Glutathione S-transferases of the α class are expressed, for example, in the liver, kidneys and testes but not in the lung. In the intestine, GST forms of the π class are expressed.

The soluble GSTs are dimeric proteins. Each subunit features an active center composed of two functional regions, namely a hydrophilic G domain, which binds the glutathione substrate, and an adjacent, hydrophobic H domain, to which the various electrophilic substrates bind (Armstrong, Chem. Res. Toxicol., 10 (1997), 2-18). The GSTs catalyze various types of reactions, examples being the opening of epoxide rings, nucleophilic aromatic substitution reactions, reversible Michael additions to α,β-unsaturated aldehydes and ketones, isomerizations, and some peroxidase reactions. Known GST substrates include numerous classes of chemical substance, examples being antibiotics, pesticides, insecticides, carcinogens, and medicinal products.

Compounds such as polycyclic aromatic hydrocarbons, phenol antioxidants, reactive oxygen molecules, isothiocyanates, trivalent arsenic compounds, barbiturates, and synthetic glucocorticoids are able to induce GST activities, in which case genes which encode the GST enzymes are activated (Hayes and Pulford, 1995). GST induction takes place principally by way of various transcription mechanisms. The regulation regions of GST-encoding genes contain elements to which the aforementioned substances bind and which are able to induce gene transcription. Known elements are, for example, the glucocorticoid, xenobiotic, and antioxidant response elements (ARE) (Eaton and Bammler, Toxicological Sciences, 49 (1999), 156-64).

Food constituents as well, examples being phytochemical substances, can induce GST activities, in which case GST forms of the π class in the intestinal region, in particular, are induced. GST induction in the intestinal tract by food constituents is being discussed as a mechanism for preventing intestinal cancer illnesses (Peters and Roelofs, Cancer Res., 52 (1992), 1886-90). Very strong inductors of GSTs are isothiocyanates, which are produced as metabolism products from glucosinolates, which are found in vegetable species belonging to the Cruciferae, such as broccoli, lettuce and brussels sprouts (Vos et al., Biochem. Pharmacol., 37 (6) (1987), 1077). Glycans act either directly or indirectly; that is, only after metabolism by the microflora located in the intestine.

Of particular importance for GST induction are food constituents which are indigestible or difficult to digest, in other words dietary fiber, which is resistant to digestion by human enzymes. This includes some carbohydrates, such as pectin, guar gum and resistant starch, which are fermented only in the intestinal tract by the bacterial flora of the large intestine, to form short-chain fatty acids (SCFAs), especially acetic acid, propionic acid and butyric acid (Bartram et al., Cancer Res., 53 (1993), 3283-88). An investigation by Treptow-van Listhaut et al. (Eur. J. Nutr., 38 (1999), 76-83) showed that rats fed with a retrograded, amylase-resistant starch had higher GST levels than rats fed with degradable starch, there being a particular increase in the levels of GST in the intestine. Stein et al. (Eur. J. Clin. Invest., 26 (1996), 84-87) showed that the activities of the SCFAs, particularly butyric acid (butyrate), included inducing the formation of glutathione S-transferases π, exerting antiproliferative effects on the human large intestine cancer cell line Caco-2, and increasing differentiation of the cells. The effects observed in the investigation are of physiological relevance insofar as the short-chain fatty acid concentrations used were below those normally encountered in the lumen of the large intestine. Moreover, butyrate has an antineoplastic effect, leads to a reduction in pH, improves intestinal function, and may prevent inflammation (Hickman, Clin. Tech. Small Animal Pract., 13 (1998), 211-16).

The fraction of dietary fiber in the food depends on numerous factors, examples including the nature of the foodstuff and the manner of its preparation. The majority of foods are low in fiber. Vegetables, certain types of fruit, nuts, seeds, and, above all, unrefined cereal products, in contrast, are rich in fiber. The significance of the preparation of the food for its fiber content is evident from the example of resistant starch. This is the part of the starch that is not digested in the small intestine and so passes unchanged into the large intestine. Thus starch from freshly boiled potatoes is broken down very effectively in the gastrointestinal tract, with only about 3% of the starch consumed passing the small intestine unchanged and passing into the large intestine. If, on the other hand, the potatoes are cooled after boiling, their fraction of resistant starch goes up by a factor of from two to four. Repeated heating and subsequent cooling intensifies the effect.

One way to compensate for the fiber deficiencies caused by foodstuffs processing or for a low-fiber diet and to prevent cancer illnesses via the food supply is to enrich foodstuffs with dietary fibers or with substances which, in a similar way to dietary fibers, pass the small intestine virtually unchanged and are fermented only in the large intestine by the intestinal flora. Many of the forms of fiber used to date to enrich foodstuffs, however, have a range of critical disadvantages and/or do not fulfill the expectations vested in them with respect to the prevention of cancer illnesses, particularly of the large intestine region.

In two long-term studies by the U.S. National Cancer Institute and the University of Arizona it was found that several years of nutrition with high-fiber food, with muesli products, for example, apparently had no effect on the frequency of cancer of the large intestine (http://www.just-another-site.de/, Apr. 20, 2000). The “Nurse Health” study as well showed that, among the 90 000 nurses participating in the study, the amount of fiber consumed had no effect on the colonic cancer risk (Schweinsberg, Int. Conference on Dietary Factors, ERNO 2 (1) (2001), 72-73). These studies, however, included only fiber substances that are not fermented in the large intestine region by the intestinal flora.

Wheat bran is frequently used as an addition to low-fiber food. As investigations on rats with respect to the incidence of tumors in the colon showed, wheat bran diets are hardly suitable for preventing cancer. Wheat bran, much like cellulose, is hardly fermented by colonic bacteria. In the case of foodstuffs enriched with wheat bran, moreover, unwanted side effects occur, such as meteorism and cramplike pains (http://www.pharmazeutische-zeitung.de). It was also found that the phytic acid, which occurs in wheat bran and is a widespread storage substance in cereals, legumes and oil seeds, considerably impairs mineral metabolism and prevents the uptake of calcium, magnesium, iron, and zinc. Just 25 g of wheat bran reduce the absorption of calcium considerably (Knox et al., Am. J. Clin. Nutr., 53 (1991), 1480-92). In older persons and those at increased risk of osteoporosis, therefore, a food enriched with wheat bran is not unproblematic.

Even the resistant starch which can be fermented in principle has a series of disadvantages. Thus it has turned out that commercially customary resistant starch is in some cases not fermentable, a fact which is obviously related to the production processes. Only resistant starch produced using special extrusion processes is butyrogenic, i.e., leads to the formation of butyric acid. Resistant starch produced under polymer-protective extrusion conditions, however, is frequently not stable (http://www.igv-gmbh.de/e/tagung/geb-hardt.htm).

The technical problem on which the present invention is based is to provide agents which are suitable for preventing cancer illnesses, especially cancer of the large intestine, and which do not have the disadvantages of the prior art forms of fiber, and processes for preparing them, the agents being easier and less expensive to prepare than the agents used conventionally, and being able to be used as a form of fiber.

The present invention solves this technical problem through the provision of a process for preparing hydrogenated condensed Palatinose and also through the provision of the hydrogenated condensed Palatinose thus prepared. The process of the invention for preparing hydrogenated condensed Palatinose comprises the catalytic hydrogenation of a solution comprising condensed Palatinose and if appropriate the separation of the hydrogenated condensed Palatinose with a degree of polymerization (DP) of 4 to 10 from the reaction mixture. The hydrogenated condensed Palatinose of the invention that is prepared in this way is a mixture in particular of hydrogenated Palatinose dimers, Palatinose trimers and Palatinose tetramers with a degree of polymerization of 4 to 10.

The hydrogenated condensed Palatinose provided in accordance with the invention is not cleaved to any notable extent either under the pH conditions of the stomach or by the enzymes of the small intestine mucosa. The hydrogenated condensed Palatinose of the invention is, surprisingly, fermented only by microorganisms in human feces, to form short-chain fatty acids having a high fraction of butyric acid, a considerably greater amount of butyric acid being formed in comparison to other forms of fermentable fiber such as resistant starch.

Since the hydrogenated condensed Palatinose of the invention, when consumed, passes virtually unchanged into the cecum and into the large intestine, and is only there fermented by the human intestinal flora, it is outstandingly suitable as a form of fiber. Since the hydrogenated condensed Palatinose of the invention dissolves readily it is particularly suitable as a form of soluble fiber which in the large intestine region, owing to the outstanding solubility, is amenable completely, or almost completely, to fermentation. Compared with frequently used forms of fiber such as wheat bran or oat bran, moreover, the hydrogenated condensed Palatinose of the invention has the advantage of containing no substances which lead to unwanted side effects.

The hydrogenated condensed Palatinose of the invention is also suitable as a highly active agent for preventing and/or treating diseases associated with oxidative stress. On the basis of in vitro studies it has been found that the products of the fermentation of condensed hydrogenated Palatinose, especially butyrate, not only increase the expression of glutathione S-transferase but also lead to an increased cellular glutathione concentration. Glutathione and glutathione S-transferases are involved in the detoxification of electrophilic extraneous substances, whose reactivity with respect to cellular macromolecules is sharply reduced. Both substances therefore possess important detoxification and protective functions with respect to cells, particularly toward the development of tumors. Butyrate, furthermore, is known to exert an antiproliferative effect on colonic cancer cells. The hydrogenated condensed Palatinose of the invention, and particularly its fermentation products, therefore has antioxidative and anticarcinogenic effects which are substantially reinforced as compared with the effects of other forms of fiber, particularly condensed Palatinose and resistant starch, owing to the considerably greater amount of butyric acid produced during fermentation.

As a consequence of the fermentation of the hydrogenated condensed Palatinose of the invention to form short-chain fatty acids, especially butyrate, there is, furthermore, a marked reduction in pH in the large intestine region, into the acidic range. On the one hand this impairs the living conditions for pathogenic intestinal microorganisms such as Clostridias and on the other hand improves the living conditions for acidophilic microorganisms, examples being the Bifidus flora and lactic acid bacteria. The hydrogenated condensed Palatinose of the invention therefore has a prebiotic effect which is substantially reinforced because of the considerably increased production of butyric acid as compared with condensed Palatinose and resistant starch.

A further feature of the hydrogenated condensed Palatinose of the invention is that in comparison to other known forms of fiber it is much better able to prevent the development of infectious diseases, since in the large intestine region on the one hand it suppresses the growth of pathogenic microbes, owing to the fermentation products that are formed, and, on the other hand, on the basis of its considerably higher availability, it is able to prevent or reduce the taking up of pathogenic microbes by human or animal epithelial cells. As a result of this the hydrogenated condensed Palatinose of the invention is better able to strengthen the immune defense and to prevent or control general infections and inflammatory diseases, especially chronic intestinal inflammation.

Because of the lower level of degradability in the digestive tract, the hydrogenated condensed Palatinose of the invention is a particularly effective modulator of the glycemic properties of foodstuffs of all kinds.

The hydrogenated condensed Palatinose of the invention can be prepared, moreover, very easily and inexpensively from condensed Palatinose, which for its part can be produced inexpensively from Palatinose. Palatinose (6-O-α-D-glucopyranosylfructose) can be prepared industrially from sucrose in accordance with DE 44 14 185 C1 by simple enzymatic rearrangement using immobilized bacterial cells, of the species Protaminobacter rubrum, Erwinia rhapontici and Serratia plymuthica, for example, or using a sucrose isomerase isolated therefrom.

The hydrogenated condensed Palatinose of the invention is prepared in accordance with the invention initially, in a first step, by catalytically hydrogenating a solution comprising condensed Palatinose.

In connection with the invention the term “condensed Palatinose” refers in particular to a mixture of Palatinose and condensation products thereof. The condensation of substances is a chemical reaction which proceeds, where appropriate, under catalytic influence and in which at least two molecules combine to form a larger molecule with the egress of a simple molecule. The term “condensed Palatinose” therefore embraces in particular a mixture of uncondensed Palatinose, Palatinose dimers, Palatinose trimers, Palatinose tetramers, Palatinose pentamers and trisaccharides. The trisaccharides consist of the condensation product of a simple sugar from hydrolyzed Palatinose and of a Palatinose disaccharide.

From the prior art there are a number of processes known for preparing condensed Palatinose from Palatinose. By way of example it is possible to prepare condensed Palatinose from an acidified aqueous solution of Palatinose by heat treatment at temperatures between 100° C. and 170° C. The water content of the initial mixture of water, organic acid and Palatinose in this case is usually about 33%, based on the Palatinose employed. In DE 38 18 884 A1 this process is used to give condensed Palatinose having the following composition: about 54% uncondensed Palatinose, about 29.8% Palatinose dimers, about 11.5% Palatinose trimers, and about 5% Palatinose tetramers. In a process of the same kind an aqueous Palatinose solution containing citric acid is used to give condensed Palatinose with a composition of about 52.4% uncondensed Palatinose, about 26% Palatinose dimers, about 12% Palatinose trimers and about 5.7% Palatinose tetramers (Mutsuo et al., J. Carbohydr. Chem., 12 (1993), 49-61). Likewise known is a process for preparing condensed Palatinose from Palatinose in which Palatinose is reacted with anhydrous hydrofluoric acid (HF) to form a mixture composed essentially of different Palatinose dimers. In the case of this process the reaction takes place in an anhydrous medium at preferably 0 to 20° C. The condensed Palatinose obtained in this process includes about 94% Palatinose dimers and about 2% uncondensed Palatinose (FR 2 680 789 A1). In a further publication the aforementioned anhydrous condensation by means of HF gives condensed Palatinose having a Palatinose dimer content of more than 73% (Defaye et al., Carbohydrate Research, 251 (1994), 1-15).

In one preferred embodiment of the invention it is envisaged that the condensed Palatinose to be hydrogenated is produced by heat-treating an aqueous Palatinose solution having a pH of 3.2 to 5.8 at a temperature of 100° C. to 170° C. under atmospheric pressure or reduced pressure. In this case the aqueous solution of the Palatinose to be condensed is prepared by dissolving Palatinose in water, in particular at a temperature of 105° C. In accordance with the invention it is envisaged that acidic catalysts are added to the aqueous Palatinose solution. Advantageously the acidic catalysts are H⁺-loaded, strongly acidic cation exchangers, organic acids, boric acid, a combination of phosphoric acid with potassium dihydrogen phosphate or ammonium sulfate. The organic acids are preferably selected from the group consisting of citric acid, malic acid, succinic acid, and tartaric acid.

In one particularly advantageous embodiment of the invention the condensed Palatinose to be hydrogenated is obtained by heat-treating an aqueous Palatinose solution in the presence of 0.02% by weight of citric acid, based on Palatinose, in vacuo at a temperature of 135° C. The condensed Palatinose thus prepared preferably comprises a mixture comprising about 48% uncondensed Palatinose, about 28% Palatinose dimers, about 12% Palatinose trimers, about 5% Palatinose tetramers, about 5% Palatinose pentamers, and about 2% hydrolysis products.

In a further preferred embodiment of the invention it is envisaged that the condensed Palatinose to be hydrogenated is obtained by reaction with anhydrous hydrofluoric acid at a temperature of 0° C. to 20° C. The reaction mixture obtained in this case preferably comprises about 73% to 94% Palatinose dimers.

In another, particularly preferred embodiment of the invention the condensed Palatinose to be hydrogenated is prepared from a Palatinose melt. The Palatinose melt is obtained by adding Palatinose to a solution of a catalytically active, acidic substance in water and heating the mixture at a temperature of 130° C. to 160° C. The mixture of Palatinose, acidic substance, and water used for preparing the melt is characterized in that the water fraction is well below 12% by weight. In accordance with the invention it is envisaged in particular that the Palatinose mixture comprises 4% to 12% by weight water and 0.05% to 0.5% by weight the acidic substance. The acidic substance can be an H⁺-loaded, strongly acidic cation exchanger, an organic acid, boric acid, a combination of phosphoric acid with potassium dihydrogen phosphate or ammonium sulfate. Preferably the organic acid is an organic acid of low volatility, and more preferably is citric acid.

In one preferred embodiment of the aforementioned process the solution of the organic acid is heated in water, before and/or during the addition of the Palatinose, to a temperature of 55° C. to 95° C., more preferably to about 75° C. The addition of Palatinose to the solution of the organic acid in water takes place preferably with stirring. The mixture of Palatinose, organic acid, and water that is used for preparing the Palatinose melt is then heated to a reaction temperature of 140° C. to 155° C., more preferably about 145° C., until the melt stage is reached, and the mixture is stirred continuously. The condensed Palatinose is obtained from the melt after about 20 to 100 minutes, preferably after 30 to 60 minutes, the temperature of the melt being held in this period at 130° C. to 160° C., preferably at 140° C. to 155° C., more preferably at 145° C.

In another preferred embodiment of the aforementioned process the melt thus obtained, after the reaction has run its course, is slaked with water, giving a syrup which comprises the condensed Palatinose. The water used for slaking the melt is preferably added in a melt/water weight ratio of 10:1 to 1:2, more preferably 5:1 to 1:1. The condensed Palatinose obtained from the Palatinose melt preferably comprises about 15% to 45% by weight uncondensed Palatinose, 35% to 60% by weight Palatinose dimers, less than 10% by weight Palatinose trimers, and less than 5% by weight Palatinose tetramers and Palatinose pentamers.

In one preferred embodiment of the present invention the condensed Palatinose obtained by one of the processes described above is depleted prior to catalytic hydrogenation in an additional process step in terms of its uncondensed Palatinose content. The depletion of the condensed Palatinose with respect to uncondensed Palatinose takes place preferably by means of chromatographic separation of the uncondensed Palatinose from the condensed Palatinose obtained. In one preferred version of this embodiment a cation exchanger loaded in particular with calcium ions is used for the chromatographic separation process. The aforementioned separation and depletion process gives a condensed Palatinose which as compared with condensed Palatinose obtained directly from an aqueous Palatinose solution advantageously has a Palatinose dimer (DP=4) content increased by about 100% and an uncondensed Palatinose (DP=2) content reduced by about 75%.

In accordance with the invention it is envisaged that the condensed Palatinose obtained above is converted into an aqueous solution and then subjected to a catalytic hydrogenation, the catalytic hydrogenation of the solution comprising condensed Palatinose taking place, in accordance with the invention, at elevated temperature under increased pressure in the presence of hydrogen and using a catalyst.

In connection with the present invention a “hydrogenation” is the introduction, normally taking place under catalysis, of hydrogen into an organic compound, in other words a reduction of said compound. A characteristic feature of the reduction or hydrogenation process is that the compound to be reduced accepts electrons. The “hydrogenation of condensed Palatinose” in connection with the present invention means a reduction of the anomeric center of unsubstituted fructose. By a “catalytic hydrogenation” is meant a hydrogenation in the presence of a catalyst, i.e., of a substance which lowers the activation energy for the hydrogenation to take place and thereby raises the reaction rate of the hydrogenation without appearing in the end product of the hydrogenation reaction.

In accordance with the invention the solution of the condensed Palatinose to be hydrogenated is prepared by dissolving condensed Palatinose in an aqueous medium, preferably in water, in a concentration of 20% to 40% by weight, preferably 30% by weight. In accordance with the invention it is envisaged that the pH of the aqueous solution is adjusted to a value of 6 to 8 using suitable agents. In one preferred embodiment of the invention the pH of the solution of the condensed Palatinose to be hydrogenated is adjusted to 7.8 by adding aqueous sodium hydroxide solution.

In accordance with the invention it is envisaged that the hydrogenation of the solution comprising condensed Palatinose takes place at a temperature of 40° C. to 140° C., in particular 60° C. to 80° C., preferably 70° C. In accordance with the invention the catalytic hydrogenation of the solution comprising condensed Palatinose takes place in the presence of hydrogen, and in one preferred embodiment of the process of the invention it is envisaged that the hydrogen used has a pressure of 150 to 230 bar, in particular 100 to 200 bar, preferably 150 bar.

In accordance with the invention the hydrogenation of the solution comprising condensed Palatinose takes place using a catalyst. In one preferred embodiment of the invention a mixture of a pure Raney metal and of a Raney metal alloy is used as catalyst, the Raney metal being preferably nickel, copper, cobalt or iron. The Raney metal alloy is preferably an alloy of nickel, copper, cobalt or iron with aluminum, tin or silicon. In a further preferred embodiment of the invention the catalyst used for the hydrogenation comprises as active component one or more metals of transition group VIII of the periodic table on a support. The active component used is preferably platinum, ruthenium, palladium and/or rhodium. The catalyst support comprises preferably activated carbon, aluminum oxide, zirconium oxide and/or titanium dioxide.

The solution comprising condensed Palatinose is preferably stirred continuously during the hydrogenation. In accordance with the invention it is envisaged in particular that the hydrogenation takes place over a period of at least 2 hours to 5 hours, preferably at least four hours.

In accordance with the invention it is envisaged that the hydrogenation of the condensed Palatinose is carried out continuously, semibatchwise or batchwise. The hydrogenation of the invention can be carried out either in a fixed-bed process or in a suspension process.

After the condensed Palatinose has been hydrogenated a product mixture is obtained, in accordance with the invention, that comprises 25% to 36% by weight hydrogenated condensed Palatinose having a DP of 4, 9% to 15% by weight hydrogenated condensed Palatinose having a DP of 6, 3% to 7% by weight hydrogenated condensed Palatinose having a DP of 8, 3% to 7% by weight hydrogenated condensed Palatinose having a DP of 10, 3% to 7% by weight unhydrogenated condensed Palatinose and 40% to 55% by weight hydrogenated uncondensed Palatinose.

In one preferred embodiment of the invention it is envisaged that the hydrogenated condensed Palatinose products having a DP of 4 to 10 that are obtained after the condensed Palatinose has been hydrogenated are separated from the reaction mixture and isolated. In accordance with the invention the separation and isolation of these reaction products can be carried out using any desired physical and/or chemical separation processes, which allow the separation of reaction products having a desired degree of polymerization.

For separating the hydrogenated condensed Palatinose products having a DP of 4 to 10 it is preferred to use chromatographic processes. In connection with the present invention “chromatographic processes” are any physical processes in which substances are separated by partition between a stationary phase and a mobile phase, the underlying separation mechanisms possibly including adsorption isotherms, distribution isotherms, reversed-phase matrices, ion pair systems, ion exchange, ion exclusion and gel permeation.

In one preferred embodiment of the invention the separation of the hydrogenated condensed reaction products takes place using gel permeation processes, which are also referred to as exclusion chromatography, molecular sieve chromatography or gel filtration processes. By “gel permeation” is meant the process in which, as a result of a sieve effect, the migration of molecules through a gel matrix having a pore structure results in a partition according to molecular size. In a particularly preferred embodiment of the invention the hydrogenated condensed Palatinose products are separated from the reaction mixture using substances such as polydextrans, polyacrylamide, agarose, etc., as the gel matrix.

In one preferred embodiment of the invention hydrogenated condensed reaction products having a DP of 4 to 10 are separated from the reaction mixture using separating columns containing Fractogel HW40S, the flow rate preferably being 600 ml/hour. The resultant fractions of hydrogenated condensed Palatinose, following further concentration using customary processes, can be freeze-dried and processed further.

After separation from the reaction mixture the hydrogenated condensed Palatinose contains 30% to 55% by weight hydrogenated condensed Palatinose having a DP of 4, 20% to 30% by weight hydrogenated condensed Palatinose having a DP of 6, 7% to 13% by weight hydrogenated condensed Palatinose having a DP of 8, and 2% to 6% by weight hydrogenated condensed Palatinose having a DP of 10.

The present invention further provides hydrogenated condensed Palatinose obtainable in accordance with one of the processes of the invention described above. The hydrogenated condensed Palatinose obtained in accordance with the invention constitutes a mixture of different hydrogenated condensed Palatinose products and comprises at least hydrogenated condensed Palatinose having a DP of 4, hydrogenated condensed Palatinose having a DP of 6, hydrogenated condensed Palatinose having a DP of 8, and hydrogenated condensed Palatinose having a DP of 10.

The hydrogenated condensed Palatinose of the invention comprises at least one compound of the formula (1) 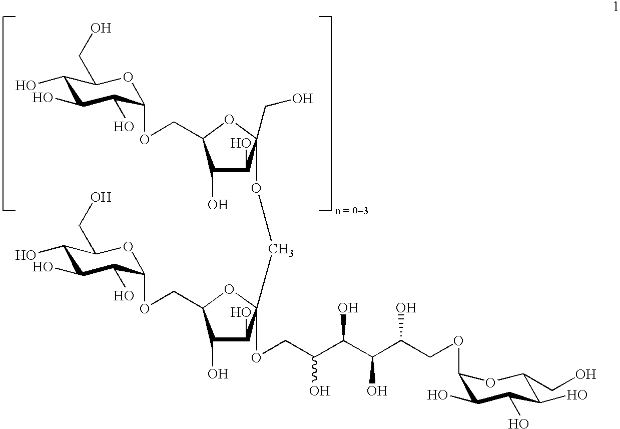
obtainable from α-2→1-linked di-Palatinose, for n=0 (DP 4):
O-α-D-glucopyranosyl-(1→6)-α-D-fructofuranosyl-(2→1)-O-[α-D-glucopyranosyl-(1→6)]-D-sorbitol and
O-α-D-glucopyranosyl-(1→6)-α-D-fructofuranosyl-(2→1)-O-[α-D-glucopyranosyl-(1→6)]-D-mannitol;
   at least one compound of the formula (2) 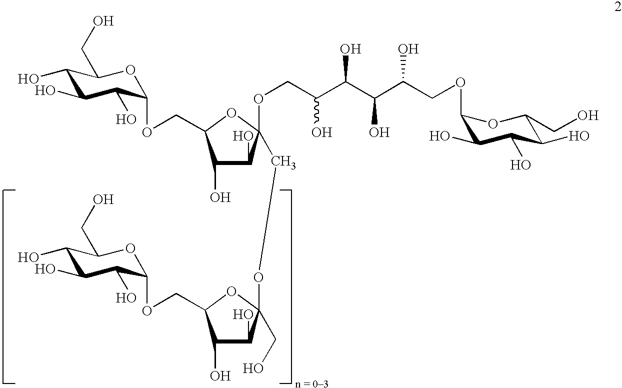
   obtainable from β-2→1-linked di-Palatinose for n=0 (DP 4):
O-α-D-glucopyranosyl-(1→6)-β-D-fructofuranosyl-(2→1)-O-[α-D-glucopyranosyl-(1→6)]-D-sorbitol and
O-α-D-glucopyranosyl-(1→6)-β-D-fructofuranosyl-(2→1)-O-[α-D-glucopyranosyl-(1→6)]D-mannitol;
   at least one compound of the formula (3) 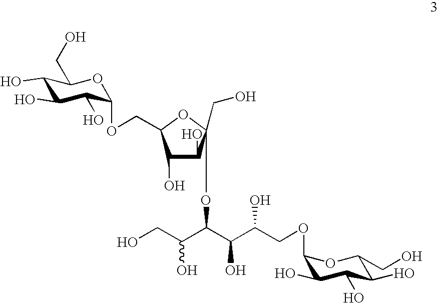
   obtainable from α-2→3-linked di-Palatinose:
O-α-D-glucopyranosyl-(1→6)-α-D-fructofuranosyl-(2→3)-O-[α-D-glucopyranosyl-(1→6)]-D-sorbitol and
O-α-D-glucopyranosyl-(1→6)-α-D-fructofuranosyl-(2→4)-O-[α-D-glucopyranosyl-(1→1)]-D-mannitol;
   at least one compound of the formula (4) 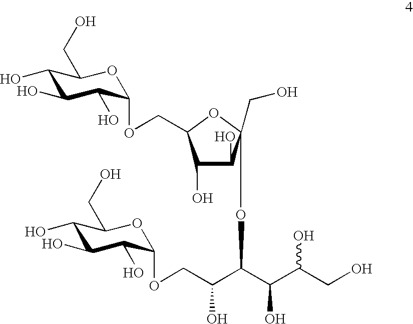
   obtainable from α-2→4-linked di-Palatinose:
O-α-D-glucopyranosyl-(1→6)-α-D-fructofuranosyl-(2→4)-O-[α-D-glucopyranosyl-(1→6)]-D-sorbitol and
O-α-D-glucopyranosyl-(1→6)-α-D-fructofuranosyl-(2→3)-O-[α-D-glucopyranosyl-(1→1)]-D-mannitol;
   at least one compound of the formula (5) 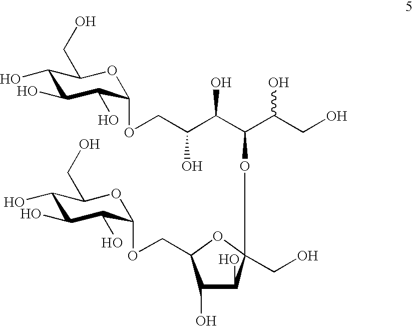
   obtainable from β-2→3-linked di-Palatinose:
O-α-D-glucopyranosyl-(1→6)-β-D-fructofuranosyl-(2→3)-O-[α-D-glucopyranosyl-(1→6)]-D-sorbitol and
O-α-D-glucopyranosyl-(1→6)-β-D-fructofuranosyl-(2→4)-O-[α-D-glucopyranosyl-(1→1)]-D-mannitol,
   and at least one compound of the formula (6) 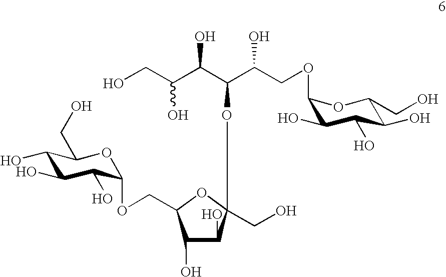
   obtainable from β-2→4-linked di-Palatinose:
O-α-D-glucopyranosyl-(1→6)-β-D-fructofuranosyl-(2→4)-O-[α-D-glucopyranosyl-(1→6)]-D-sorbitol and
O-α-D-glucopyranosyl-(1→6)-β-D-fructofuranosyl-(2→3)-O-[α-D-glucopyranosyl-(1→1)]-D-mannitol;

Preferably the hydrogenated condensed Palatinose of the invention has the following composition: 30% to 55% by weight hydrogenated condensed Palatinose having a DP of 4, 20% to 30% by weight hydrogenated condensed Palatinose having a DP of 6, 7% to 13% by weight hydrogenated condensed Palatinose having a DP of 8, and 2% to 6% by weight hydrogenated condensed Palatinose having a DP of 10. The fraction of hydrogenated condensed Palatinose having a DP of 4 is preferably 35% to 50% by weight. Preferably the fraction of hydrogenated condensed Palatinose having a DP of 6 is 22% to 28% by weight. The fraction of hydrogenated condensed Palatinose having a DP of 8 is preferably 8% to 12% by weight. The fraction of hydrogenated condensed Palatinose having a DP of 10 is preferably 3% to 5% by weight. Preferably the hydrogenated condensed Palatinose of the invention additionally comprises 6% to 12% by weight unhydrogenated condensed Palatinose having a DP of 4.

The hydrogenated condensed Palatinose of the invention may comprise additional constituents, examples being compounds having a DP of 1, such as glucose, fructose, sorbitol or mannitol, compounds having a DP of 2, such as isomaltulose or Isomalt, compounds having a DP of 3, such as unspecified trisaccharides, and compounds having a DP of 4, such as di-Palatinose dianhydrides.

In accordance with the invention it has been shown that the hydrogenated condensed Palatinose of the invention is, advantageously, resistant or virtually resistant to breakdown in the mammalian stomach and/or by the enzymes of the mammalian digestive tract.

By means of in vitro investigations it has been shown that the hydrogenated condensed Palatinose prepared in accordance with the invention, in HCl solutions having a pH of 2.0, in other words under conditions comparable with those to be encountered in the mammalian stomach, surprisingly, undergoes only limited hydrolysis or none at all. From further in vitro investigations it is apparent that hydrogenated condensed Palatinose is not broken down by pancreatic enzymes, including for example hydrolases, especially carbohydrate-cleaving enzymes such as α-amylase, which cleave α-1,4-glucans (starch, glycogen) to maltose and malto-oligosaccharides. Nor do the enzyme complexes situated in the mucosa in the small intestine, namely saccharase/isomaltase and glucoamylase/maltase, cleave the hydrogenated condensed Palatinose product of the invention to anything more than a limited extent, if at all. These enzyme complexes normally ensure that the maltose and sucrose disaccharides, and in part malto-oligosaccharides as well, that reach the small intestine are cleaved to monosaccharides and as such pass via the intestinal wall into the bloodstream. The hydrogenated condensed Palatinose of the invention is therefore neither hydrolyzed by the pH conditions of the stomach nor degraded to any notable extent by the human or animal enzymes of the digestive tract.

In accordance with the invention it has been demonstrated that the hydrogenated condensed Palatinose of the invention is fermented in vitro by microorganisms of the human feces, i.e., microorganisms of the intestinal flora. Formed in the fermentation supernatant in this case are short-chain fatty acids, particularly butyric acid, the amount of short-chain fatty acids formed, and particularly the amount of butyrate formed, being markedly higher than in the case of other forms of fermentable fiber. The amount of butyrate produced in the fermentation of the hydrogenated condensed Palatinose of the invention is much higher, for example, than the amount of butyrate obtained when resistant starch is fermented. These metabolites, formed by the intestinal bacteria, are responsible for the induction of glutathione S-transferase, an enzyme which is able to afford the cells protection against carcinogens and oxidants.

The induction of glutathione S-transferase by the fermentation products of the hydrogenated condensed Palatinose of the invention was demonstrated in further tests in vitro. The supernatant formed in the fermentation of hydrogenated condensed Palatinose by intestinal bacteria led to a significant increase in glutathione S-transferase activity in the human colon cell line HT 29. The GST activity induced by the fermentation products of hydrogenated condensed Palatinose is markedly higher than in the case of controls without carbohydrate, controls with unhydrogenated condensed Palatinose, and controls with resistant starch. The intracellular glutathione content as well was increased significantly, by 60% compared to controls, by hydrogenated condensed Palatinose. Both glutathione and glutathione S-transferase are known to increase the protection of the cells with respect to carcinogens and oxidants.

In summary, the results of the investigations conducted show that the hydrogenated condensed Palatinose prepared using the process of the invention behaves similarly in the digestive tract to resistant starch or poorly degradable dietary fiber; that is, it is fermented only in the large intestine region, by the intestinal flora located there, with the formation of short-chain fatty acids. The fermentation products, particularly the resultant butyric acid, of hydrogenated condensed Palatinose, like the fermentation products of comparable, relatively indigestible dietary fiber or resistant starch, lead to an intracellular increase in the glutathione content and in the content of glutathione S-transferase, which catalyzes glutathione reactions, the intracellular content of the two components being increased significantly in comparison to resistant starch.

One particularly preferred embodiment of the invention therefore relates to the use of the hydrogenated condensed Palatinose of the invention as an agent or active substance for the treatment and/or prophylaxis of diseases which are associated with oxidative stress, especially for the treatment and/or prophylaxis of cancer illnesses, particularly those of the large intestine region.

On the basis of the effects—known in the prior art and confirmed in the present invention—of the fermentation products of hydrogenated condensed Palatinose, in other words short-chain fatty acids, and particularly their inductive effects on the intracellular synthesis of the antioxidant glutathione and of glutathione S-transferase, their antiproliferative effects on cancer cells, their antineoplastic effects, and their ability to increase cell differentiation, the hydrogenated condensed Palatinose product of this application is outstandingly suitable for use as an agent for the treatment and/or prophylaxis of the aforementioned diseases.

In connection with the present invention a “disease” or “illness” is understood to refer to disruptions to the processes of life, and/or states of deficiency, in an organism that are associated with subjectively perceived and/or objectively determinable physical changes. “Oxidative stress” is a condition in which in the body or in specific organs or tissues there is an imbalance between the formation and the breakdown of free radicals, “free radicals” being molecules, or atoms and fragments thereof, that are characterized by a single impaired electron and are therefore extremely reactive. By “diseases which are induced by oxidative stress or are related to it” are meant, in accordance with the invention, diseases such as cancer illnesses, particularly of the large intestine region, diabetes I and II, hypertension, stroke, male infertility, rheumatic illnesses, coronary artery illnesses, acute myocardial infarction, and chronic inflammatory diseases, particularly of the intestinal region. “Agents for treating diseases” are substances which in the body act directly as an active substance on cellular macromolecules and thereby induce a series of functional changes, in other words bring about a biological effect, or whose degradation products or fermentation products function in the body as active substances.

In a further preferred embodiment the present invention provides for the use of the hydrogenated condensed Palatinose prepared in accordance with the invention as an agent or active substance for strengthening the immune defense against general infections.

Further embodiments envisage the use of the hydrogenated condensed Palatinose of the invention as an active substance for treating and/or preventing constipation and as an active substance for reestablishing and maintaining a healthy microorganism flora in the digestive tract.

A further embodiment envisages the use of the hydrogenated condensed Palatinose of the invention as an active substance for improving the absorption of food constituents, particularly of minerals such as calcium, in the animal or human digestive tract, thereby preventing and/or reducing, in particular, phenomena of dietary deficiency.

Another embodiment of the invention provides for the use of the hydrogenated condensed Palatinose of the invention as an active substance for preventing and/or treating diarrhea illnesses, particularly those brought about by increased ion secretion and/or deficient ion absorption (secretory diarrhea), which occurs in the case of the majority of infections of the intestine with microorganisms (i.e., bacterial or viral enteritis), for example, the travel diarrhea brought about by enterotoxin-forming E. coli strains and also other bacteria and parasites that are intestinal pathogens, and amebic dysentery.

The present invention further provides for the use of the condensed Palatinose of the invention as an active substance for the prophylaxis of infectious diseases, for the prophylaxis of intestinal illnesses, for the prophylaxis of colon carcinogenesis, for the prophylaxis of inflammatory illnesses and/or for the prophylaxis of osteoporosis.

In accordance with the invention it is envisaged in particular that the hydrogenated condensed Palatinose is administered in a dose sufficient to cure, or in particular to prevent, for example, the state of a disease caused by oxidative stress or the state of an infectious disease, to arrest the progress of such a disease and/or to alleviate the symptoms. Preferably the hydrogenated condensed Palatinose of the invention is administered orally, so that it can pass via the gastrointestinal tract into the large intestine. The dosage of the hydrogenated condensed Palatinose depends, among other factors, on the administration form, on the age, sex, and body weight of the organism to be treated, especially of the human being or animal to be treated, and on the severity of the illness.

In one preferred embodiment of the invention it is envisaged that the hydrogenated condensed Palatinose of the invention is administered in the form of a pharmaceutical composition in order to treat, for example, diseases associated with oxidative stress, or infections, and/or to prevent said diseases or infections.

In connection with the present invention a “pharmaceutical composition” or a “drug” is a mixture used for diagnostic, therapeutic and/or prophylactic purposes, in other words to promote or reestablish the health of a human or animal body, which comprises at least one natural or synthetically prepared active substance which produces the therapeutic effect. The pharmaceutical composition may be either a solid or a liquid mixture. By way of example a pharmaceutical composition comprising the active substance may comprise one or more pharmaceutically acceptable excipients. Furthermore, the pharmaceutical composition may comprise additives that are normally used in the technical field, such as stabilizers, manufacturing agents, release agents, disintegrants, lubricants, colorants, odorants, flavors, emulsifiers or other substances normally used for preparing pharmaceutical compositions.

In accordance with the invention it is envisaged in particular that the pharmaceutical composition comprising hydrogenated condensed Palatinose has the form of a pharmaceutical composition for oral administration, in particular the form of a suspension, tablet, pill, capsule, granules, powder or of a similarly suitable administration form. Although the hydrogenated condensed Palatinose used in accordance with the invention is insensitive to gastric acid, the hydrogenated condensed Palatinose may be included in drug forms which have a gastric-juice-resistant (enteric) coating. In such drug forms the active substances included in the pharmaceutical composition are able to pass through the stomach unhindered and are preferentially released only in the upper or middle sections of the intestine. The composition of enteric coatings, and processes for producing such enteric coatings, are known in the technical field. In one particularly preferred embodiment of the invention use is made of drug forms which have a retarded active-substance release mechanism, in order thus to allow longer-term therapy of diseases caused by oxidative stress. The construction and the composition of such drug forms with retarded active-substance release are likewise known in the technical field.

In a further particularly preferred embodiment of the invention it is envisaged that the pharmaceutical composition comprising hydrogenated condensed Palatinose is used as part of a combination therapy for the treatment, and in particular for the prophylaxis, of diseases caused, for example, by oxidative stress. In accordance with the invention, then, it is envisaged that, in addition to the active substance hydrogenated condensed Palatinose, at least one further active substance and/or at least one further drug is administered at the same time for the same indication. The combined use of hydrogenated condensed Palatinose and the at least one additional active substance or drug may be aimed at intensifying therapeutic or prophylactic effects, but may also act on different biological systems in the organism and so reinforce the overall effect. Hydrogenated condensed Palatinose and the at least one additional drug may be administered either separately or in the form of set combinations.

The selection of the additional drug or active substance depends primarily on the specific disease to be treated and on its severity. Where the illness, for example, is an illness associated with oxidative stress, such as a manifested colonic carcinoma, a basic chemotherapy that may be prescribed by the doctor, employing 5-fluorouracil, for example, may be supported by simultaneous administration of hydrogenated condensed Palatinose. If the illness is manifested diabetes, then, for example, the drug therapy of macroangiopathy in the diabetic, using platelet aggregation inhibitors, may be supported by simultaneous administration of the hydrogenated condensed Palatinose of the invention.

In a further preferred embodiment of the invention it is envisaged that the use of the hydrogenated condensed Palatinose for preventing and/or treating diseases caused, for example, by oxidative stress, or infections, is effected by administering the hydrogenated condensed Palatinose as an addition to animal feeds or to drinking water. The hydrogenated condensed Palatinose thus passes along with the ingested food into the digestive tract of an animal, with subsequent fermentation by the flora in the large intestine region. Supplying the hydrogenated condensed Palatinose used in accordance with the invention by way of the food is especially suitable for the prophylaxis of infectious diseases or diseases caused, for example, by oxidative stress. Long-term prophylaxis of such illnesses is possible when animals are fed regularly with feedstuffs comprising hydrogenated condensed Palatinose.

In connection with the present invention the term “feeds” or “animal feedstuffs” means any substances or mixtures of substances that are intended to be fed, in unchanged, prepared, modified or processed condition, to animals. Animal feeds may be in either solid or liquid form. The terms “feeds” and “animal feedstuffs” therefore also embrace drinking water for animals. The feeds may be either single feeds or mixed feeds. The active substances of the invention can be admixed to the animal feed in either dissolved form or solid form. For administration to livestock such as pigs, the active substances of the invention can be admixed in powder form, for example, to the mineral mixtures that are used for animal nutrition.

The hydrogenated condensed Palatinose used in accordance with the invention may likewise be added, in accordance with the invention, to the drinking water for animals. The addition of the hydrogenated condensed Palatinose to drinking water takes place preferably immediately prior to use, by adding the hydrogenated condensed Palatinose with drinking water, in the form for example of powders or granules, so that the substances used in accordance with the invention can preferentially be dissolved rapidly.

In one further preferred embodiment of the invention it is envisaged that the use of the hydrogenated condensed Palatinose for preventing and/or treating infections or diseases caused, for example, by oxidative stress is effected by using the hydrogenated condensed Palatinose as an addition to foodstuffs, to dietetic foods or to drinking water intended for human consumption. The hydrogenated condensed Palatinose therefore passes, together with the ingested food, into the digestive tract of the human being, with subsequent fermentation by the flora in the large intestine region. Supplying the hydrogenated condensed Palatinose used in accordance with the invention by way of the food is especially suitable for the prophylaxis of infectious diseases or diseases caused, for example, by oxidative stress. Long-term prophylaxis of such illnesses is possible if foodstuffs comprising hydrogenated condensed Palatinose are consumed regularly.

In connection with the present invention foodstuffs are substances which are intended to be consumed in unchanged, prepared or processed state by humankind. Foodstuffs, in addition to their natural constituents, may include further substances, which may be natural or synthetic in origin and may have entered the foodstuff intentionally or unintentionally. Foodstuffs may be in either solid or liquid form. The term “foodstuff” therefore embraces all kinds of drinks, including drinking water, which are intended for human consumption. The hydrogenated condensed Palatinose used in accordance with the invention may be admixed to the foodstuff either in dissolved form or in the solid state.

In connection with the present invention “dietetic foods” are foodstuffs which are intended to serve a particular nutritional purpose by supplying particular nutrients or other substances which have a nutrition-physiological effect, in a specific portion or in a specific form. Dietetic foods differ critically from foodstuffs of comparable type in their composition or in their properties. Dietetic foods can be used in cases where it is necessary to meet particular nutritional requirements because of diseases, functional defects or allergic reactions to individual foodstuffs and/or ingredients thereof. Dietetic foods may likewise be present in either solid or liquid form.

A further embodiment of the invention envisages the use of the hydrogenated condensed Palatinose of the invention as a pharmaceutical carrier in a pharmaceutical composition.

The present invention likewise provides for the use of the hydrogenated condensed Palatinose prepared in accordance with the invention for preparing a pharmaceutical composition intended for the treatment and/or prophylaxis of diseases caused by oxidative stress.

Another preferred embodiment envisages the use of the hydrogenated condensed Palatinose of the invention for preparing a pharmaceutical composition for strengthening the immune defense against general infections.

A preferred embodiment of the invention envisages the use of the hydrogenated condensed Palatinose of the invention as an addition to foodstuffs and drinks that are intended for human consumption.

In one preferred embodiment of the invention it is therefore envisaged that the hydrogenated condensed Palatinose prepared in accordance with the invention is used as fiber, in particular as soluble fiber, in the foodstuffs. In connection with the present invention “fiber” means a food constituent which is indigestible for human or animal enzymes but which is at least partly fermented by large intestine bacteria and hence to a small extent can be utilized for energy by the human or animal body. “Soluble fiber” is soluble in solutions, especially aqueous solutions. When used as fiber the hydrogenated condensed Palatinose of the invention regulates the energy density which results from the fraction of the main nutrients, and regulates the digestion process with regard to the transit time and to absorption in the small intestine. The hydrogenated condensed Palatinose of the invention is a particularly suitable soluble fiber on account of the fact that, owing to its very good solubility in water, it is in dissolved form in the large intestine region and consequently can be fermented completely or almost completely by the intestinal flora. As compared with other forms of fiber that are frequently used, such as wheat bran or oat bran, the hydrogenated condensed Palatinose of the invention, when used as fiber, has the advantage, moreover, that it includes no substances which lead to unwanted side effects.

Another embodiment of the invention relates to the use of the hydrogenated condensed Palatinose of the invention as prebiotic fiber. Because of the fermentation of the hydrogenated condensed Palatinose of the invention to form short-chain fatty acids, particularly butyrate, in large amount, there is a marked reduction in pH in the large intestine region, into the acidic range, when hydrogenated condensed Palatinose is used. Because of the reduced pH in the large intestine region, there is a deterioration in the living conditions for pathogenic intestinal microorganisms, and at the same time there is an improvement in the living conditions for acidophilic microorganisms. The condensed Palatinose of the invention thus serves in particular, in accordance with the invention, as a dietary fiber source.

In one preferred embodiment the hydrogenated condensed Palatinose of the invention is used in combination with other soluble or insoluble, fermentable or nonfermentable forms of fiber. In one preferred version of this embodiment the hydrogenated condensed Palatinose of the invention is used in combination with at least one further form of fiber selected from the group of forms of fiber consisting of soluble fiber such as short-chain fructo-oligosaccharides, long-chain fructo-oligosaccharides, galacto-oligosaccharides, hydrolyzed guar gum, such as “Sunfiber” or “Benefiber”, lactulose, xylo-oligosaccharides, lactosucrose, malto-oligosaccharides, such as “Fibersol-2” from Matsutani, isomalto-oligosaccharides, gentio-oligosaccharides, glucosyl sucrose, such as “Coupling Sugar” from Hayashibara, soybean oligosaccharides, chito-oligosaccharides, chitosan oligosaccharides, and insoluble fiber, such as resistant starch, oat fiber, wheat fiber, vegetable fiber, from peas or tomatoes, for example, fruit fiber, from apples, berries and fruits of the carob tree, for example, such as “Caromax” from Nutrinova, celluloses and sugar beet fiber, such as “Fibrex” from Danisco.

Besides mixtures of the hydrogenated condensed Palatinose of the invention with at least one of the aforementioned forms of fiber, preference is also given in accordance with the invention to mixtures of the hydrogenated condensed Palatinose of the invention, alone or in conjunction with at least one of the aforementioned forms of fiber, with cultures of probiotic lactobacteria, bifidobacteria, known as “synbiotics”. Depending on the use and form of administration, the added probiotic bifidobacteria cultures are in the form of live cultures or in the form of dry cultures or long-life cultures.

The hydrogenated condensed Palatinose of the invention, alone or in conjunction with at least one of the aforementioned forms of fiber and/or with cultures of probiotic bifidobacteria, thus serves, in accordance with the invention, as a dietary fiber source, for the treatment and/or prevention of constipation, the reestablishment and maintenance of a healthy microorganism flora in the digestive tract, improving the availability and the absorption of food constituents, such as minerals, in the animal or human digestive tract in general for supporting and reestablishing health, particularly for reconvalescence, and prevents, as set out above, the development of large intestine tumors and of inflammatory intestinal illnesses. With preference in accordance with the invention the hydrogenated condensed Palatinose of the invention also serves for modulating and supporting the immune system of the human and animal body.

In another preferred embodiment the invention provides for the use of the hydrogenated condensed Palatinose of the invention for modulating the glycemic properties of foodstuffs or confectionery, especially for specialty nutrition, infant nutrition or nutrition of persons having defects in glucose/insulin metabolism. By glycemic response is meant the change in blood glucose level following intake of a readily digestible carbohydrate. The strongest glycemic response is occasioned by those carbohydrates of which, following oral intake, glucose can be rapidly released and absorbed, by means of salivary, pancreatic or small-intestine enzymes. In the healthy organism a rise in blood glucose produces release of insulin, insulin stimulating the uptake of glucose by peripheral tissue, skeletal muscles for example, so that the blood level falls back to the base level. The hydrogenated condensed Palatinose of the invention is able to lower the glycemic index in foodstuffs of all kinds and can therefore be used for the prophylaxis and/or therapy of diabetes mellitus (type II) and other metabolic illnesses, preferably as a constituent of dietetic foodstuffs.

A further preferred embodiment of the invention envisages the use of the hydrogenated condensed Palatinose of the invention as a sweetener. The hydrogenated condensed Palatinose of the invention possesses a sweetening power of approximately 34% relative to sucrose (100%). The hydrogenated condensed Palatinose of the invention can therefore be used not only as soluble fiber, with the aforementioned positive properties associated therewith, but also as a sugar replacer and/or sweetener, especially in dietetic products. Since the hydrogenated condensed Palatinose of the invention is not broken down by the human oral flora, it has advantageous acariogenic properties. Sweeteners comprising hydrogenated condensed Palatinose are therefore advantageously distinguished by their acariogenicity. The invention accordingly also provides a sweetener comprising the condensed Palatinose of the invention.

A further preferred embodiment of the invention envisages the use of the hydrogenated condensed Palatinose of the invention for preparing foodstuffs, confectionery, and animal feedstuffs. Envisaged in particular is the use of the hydrogenated condensed Palatinose of the invention for preparing acidic foodstuffs having a pH of 2 to 5, especially 2 to 4. Acidic foodstuffs of this kind support the prebiotic effect of the hydrogenated condensed Palatinose of the invention. With particular preference the hydrogenated condensed Palatinose of the invention is used for preparing fruit juices or fruit-juice preparations.

The present invention likewise provides foodstuffs of all kinds which comprise the hydrogenated condensed Palatinose of the invention alone or in conjunction with at least one further form of fiber and/or with cultures of probiotic Bifidobacteria. The invention envisages that the at least one further form of fiber is selected from the group of forms of fiber consisting of soluble fiber such as short-chain fructo-oligosaccharides, long-chain fructo-oligosaccharides, galacto-oligosaccharides, hydrolyzed guar gum, such as “Sunfiber” or “Benefiber”, lactulose, xylo-oligosaccharides, lactosucrose, malto-oligosaccharides, such as “Fibersol-2” from Matsutani, isomalto-oligosaccharides, gentio-oligosaccharides, glucosyl sucrose, such as “Coupling Sugar” from Hayashibara, soybean oligosaccharides, chito-oligosaccharides, chitosan oligosaccharides, and insoluble fiber, such as resistant starch, oat fiber, wheat fiber, vegetable fiber, from peas or tomatoes, for example, fruit fiber, from apples, berries and fruits of the carob tree, for example, such as “Caromax” from Nutrinova, celluloses and sugar beet fiber, such as “Fibrex” from Danisco.

Since the hydrogenated condensed Palatinose of the invention is hardly cleaved under the pH conditions of the stomach and by the enzymes of the small intestine mucosa, the foodstuffs of the invention which comprise the hydrogenated condensed Palatinose of the invention are, advantageously, reduced-calorie foodstuffs.

In a preferred embodiment of the invention the foodstuffs of the invention are dairy products or milk products, examples being cheese, butter, yogurt, kefir, quark, sour milk, buttermilk, cream, condensed milk, dry milk, whey, lactose, milk protein, milk mixture, half-fat milk, whey mixture and milk fat products. In a further preferred embodiment of the invention the foodstuffs of the invention are bakery products, particularly bread, including cookies, and fine bakery products, including nonperishable bakery products. In further embodiments of the invention the foodstuffs of the invention are spreads for bread, margarine products and cooking fats, and also instant products and stock products. In other preferred embodiments of the invention the foodstuffs of the invention are fruit products, especially marmalades, jams, jellies, fruit conserves, fruit pulp, fruit juices, fruit juice concentrates, fruit nectar and fruit powders. The foodstuffs of the invention comprising hydrogenated condensed Palatinose may in accordance with the invention also be vegetable products, especially vegetable conserves, vegetable juices, and vegetable pulp. In further embodiments of the invention the foodstuffs comprising hydrogenated condensed Palatinose are nonalcoholic beverages, beverage base materials, and beverage powders.

The present invention provides in a further preferred embodiment confectionery comprising hydrogenated condensed Palatinose of the invention. The hydrogenated condensed Palatinose of the invention possesses a sweetening power of approximately 34% in relation to sucrose (100%) and is therefore also used with particular advantage as a sugar replacer and/or sweetener in confectioneries, particularly in dietetic products. The confectioneries of the invention are advantageously distinguished by their acariogenicity. The confectioneries of the invention comprise, in particular, chocolate products, hard caramels, soft caramels, fondant products, jelly products, licorices, marshmallow products, desiccated coconut, coated chocolate candies, compressed candy products, candied fruits, cracknel, nougat products, ice confections, marzipan, chewing gum, muesli bars, and also ice cream or alcoholic or nonalcoholic sweet drinks.

A further preferred embodiment of the invention provides pharmaceutical compositions or drugs which comprise hydrogenated condensed Palatinose of the invention as an active substance. In accordance with the invention the drugs comprising hydrogenated condensed Palatinose can be used in particular for the treatment and/or prophylaxis of diseases associated with oxidative stress.

Further advantageous embodiments of the invention are apparent from the dependent claims.

The invention is illustrated with reference to the following examples.

### EXAMPLE 1

Preparation of Condensed Palatinose

300 g of crystalline Palatinose were dissolved in a steel vessel, following the addition of 90 g of water, with stirring at 105° C. and, with subsequent addition of citric acid (0.02%, based on Palatinose), were concentrated under vacuum to a final temperature of 135° C. After 135° C. had been reached this temperature was held for 30 minutes. This was followed by cooling, and the reaction product was dissolved with fully deionized water. The resulting solution was purified by ion exchange on an H⁺-loaded cation exchanger and an OH⁻-loaded anion exchanger. Gel permeation chromatography was used in order to determine the following composition:

| | |
|---|---|
| Range DP1 | 2% |
| Range DP2 | 48% |
| Range DP4 | 28% |
| Range DP6 | 12% |
| Range DP8 | 5% |
| Range DP10 | 5% |

The range DP2 corresponds substantially to isomaltulose.

The DP ranges were determined using Raftilose® L40 or Raftiline® St. as control.

### EXAMPLE 2

a) Hydrogenation of Condensed Palatinose

500 ml of the 30% strength reaction solution obtained in Example 1, containing 50% condensed Palatinose, 2% monosaccharides and 40% isomaltulose, were adjusted to a pH of 7.8 by adding 1 N NaOH, with stirring. Hydrogenation took place by means of a nickel catalyst (200 g moist mass) in the presence of hydrogen (150 bar) at 70° C. with stirring.

Samples were taken after 0, 1, 2, 3 and 4 hours and tested for their isomaltulose content and their 1,6-GPS and 1,1-GPM content. The hydrogenation was ended following quantitative conversion of the free isomaltulose to 1,1-GPM and 1,6-GPS.

Result:

| | [hours] | | | | |
|---|---|---|---|---|---|
| g/l | 0 | 1 | 2 | 3 | 4 |
| Isomaltulose | 150.1 | 82.5 | 38.6 | 13.5 | 0 |
| 1,6-GPS | 0 | 38.1 | 59.6 | 72.1 | 78.7 |
| 1,1-GPM | 0 | 32.1 | 49.5 | 60.9 | 65.6 |
| Total | 150.1 | 152.7 | 147.7 | 146.5 | 144.3 |

After a reaction time of 4 hours the isomaltulose contained in the condensed Palatinose solution (see Example 1) had undergone complete hydrogenation to 1,6-GPS and 1,1-GPM. The solution obtained after the catalyst was separated off was purified by ion exchange on an H⁺-loaded cation exchanger and an OH⁻-loaded anion exchanger.

The total of isomaltulose, 1,6-GPS and 1,1-GPM showed virtually no change during the reaction time; in other words, the amount of condensed saccharides remained constant.

b) Isolation of Hydrogenated Condensed Palatinose

200 ml of a solution containing 15 of hydrogenated condensed Palatinose were chromatographed by means of gel permeation chromatography (Fractogel HW40S, 3 separating columns each 120 cm long, 10 cm in diameter) at 55° C. with a flow rate of 600 ml/hour. The fractions containing the hydrogenated condensed Palatinose with a DP of 4-10 were combined, concentrated and freeze-dried.

DP Distribution of the Hydrogenated Condensed Palatinose Isolated

| Range | area % |
|---|---|
| DP4 | 59 |
| DP6 | 25 |
| DP8 | 10 |
| DP10 | 4 |
| DP > 10 | 2 |

The lyophilizate obtained was characterized and used in in vitro analyses for digestibility and fermentability with human feces.

### EXAMPLE 3

Characterization of Hydrogenated Condensed Palatinose

Partial HCl hydrolysis of the hydrogenated condensed Palatinose product isolated in Example 2 was carried out as follows:

0.9 ml of a solution containing 1% hydrogenated condensed Palatinose was mixed with 0.1 ml of 1 M HCl and then incubated at 47° C. for a maximum of 8 hours. Sampling took place after 0, 1, 2, 4, 6 and 8 hours. The analyses were carried out by means of HPAEC.

Result:

| | | [hours] | | | | |
|---|---|---|---|---|---|---|
| mg/l | 0 | 1 | 2 | 4 | 6 | 8 |
| 1,6-GPS | 0 | 12.8 | 13.6 | 14.1 | 14.2 | 14.4 |
| 1,1-GPM | 0 | 13.3 | 14.1 | 14.7 | 15.3 | 15.4 |
| Isomaltulose | 0 | 50.0 | 54.5 | 57.0 | 57.3 | 57.9 |
| Total | 0 | 76.1 | 82.2 | 85.5 | 86.8 | 87.7 |
| Isomaltulose/ | 0 | 2:1 | 2:1 | 2:1 | 2:1 | 2:1 |
| 1,6-GPS, | | | | | | |
| 1,1-GPM | | | | | | |
| ratio | | | | | | |

The gentle hydrolysis resulted in controlled cleavage of the fructosidic bonds in the condensed Palatinose molecules without hydrolysis of the isomaltulose, 1,6-GPS and 1,1-GPM disaccharides.

All reducing ends in the condensed Palatinose molecules were hydrogenated to 1,6-GPS or 1,1-GPM.

The ratio between isomaltulose and the two 1,6-GPS and 1,1-GPM substances remained constant over the period of hydrolysis and amounted to 2:1.

### EXAMPLE 4

Stability of the Hydrogenated Condensed Palatinose in Stomach and Small Intestine

Stability in the Stomach

The stability of a substance on passage through the stomach can be ascertained by determining the rate of hydrolysis at a pH of 2.0, using sucrose and 1-kestose as controls.

For this purpose a solution containing 1% hydrogenated condensed Palatinose was incubated at a pH of 2.0 (0.01 M HCl) at 37° C. for 3 hours. Samples were taken from the reaction mixture after 60, 120 and 180 minutes. They were analyzed by means of HPAEC techniques.

Result:

Report as hydrolysis rates in %

Incubation time

| Substance | 0 min. | 60 min. | 120 min. | 180 min. |
|---|---|---|---|---|
| Sucrose | 0% | 2% | 5% | 8% |
| 1-Kestose | 0% | 11% | 25% | 36% |
| Condensed | 0% | 4% | 7% | 10% |
| Palatinose, | | | | |
| hydrogenated | | | | |

From the table it is apparent that hydrogenated condensed Palatinose underwent only limited cleavage under the pH conditions prevailing in the stomach.

Stability to Pancreatic Enzymes

The pancreatic secretion contains a large number of hydrolases, including carbohydrate-cleaving enzymes which effect preferential cleavage of α-1,4-glucans (starch, glycogen) to maltose and malto-oligosaccharides.

The test of the stability of saccharides to pancreatic enzymes was carried out as follows:

Solutions Required:

20 mM Na phosphate buffer, pH 7.0 plus 6 mM NaCl (solution 1)
1% strength starch solution (soluble starch according to Zulkowski) in solution 1
1% strength condensed Palatinose solution, hydrogenated, in solution 1
0.2% pancreatin (Sigma) dissolved in solution 1

Reaction Mixtures:

| Components | Sample | Control |
|---|---|---|
| Saccharide solution | 3.0 ml | — |
| Starch solution | — | 3.0 ml |
| Enzyme solution | 0.1 ml | 0.1 ml |

After 210 minutes of incubation in a thermal mixer (with shaking at intervals) at 37° C. the reaction was ended by heating at 95° C. for 15 minutes. The samples were then analyzed by HPAEC. The sample containing starch was fully hydrolyzed beforehand by heating in 1 M HCl at 95° C. for 3 hours.

Result:

| Substance | Degradation rate (%) |
|---|---|
| condensed Palatinose, | <1 |
| hydrogenated | |
| soluble starch | 85 |

It is evident that hydrogenated condensed Palatinose was not cleaved by the pancreatic enzymes.

Cleavability by Small-Intestine α-Glucosidases

The enzyme complexes, saccharase/isomaltase and glucoamylase/maltase, situated in the mucosa of the small intestine ensure in vivo that the disaccharides maltose and sucrose, and to some extent malto-oligosaccharides as well, that enter the small intestine are cleaved to monosaccharides and as such are able to pass via the intestinal wall into the bloodstream.

The test of the stability of hydrogenated condensed Palatinose to these enzymes was carried out as follows:

Enzyme Isolation:

The saccharase/isomaltase (SI) and glucoamylase/-maltase (GM) enzyme complexes were isolated from porcine small intestine by the method of H. Heymann (Dissertation, Hannover, 1991).

The cleavability of the saccharide of the invention by small-intestine α-glucosidases was determined as follows:

Solutions Required:

triethanolamine (TRA) buffer, 0.1 M, pH 7.0
saccharide, 1% strength solution in TRA buffer
maltose or sucrose, as control substances, 1% strength in TRA buffer
mucosa enzyme, dissolved in TRA buffer
   Reaction Mixture:

1.2 ml of the carbohydrate solution, at a controlled temperature of 37° C., were admixed with 0.7 U of the saccharase/isomaltose or glucoamylase/maltase enzyme complex, respectively, at t=0. Mixing was followed by incubation at 37° C. The reaction was stopped after 2 hours by heating at 95° C. for 15 minutes. The monosaccharides formed and also the test substances used were assayed by HPAEC.

Result:

Hydrolysis rate [%]

| Saccharide | SI | GM |
|---|---|---|
| Sucrose | 98 | — |
| Maltose | 95 | — |
| Maltose | — | 96 |
| condensed Palatinose, | 7 | 1 |
| hydrogenated | | |

The results show that under the chosen conditions there was virtually complete hydrolysis of sucrose or maltose in the case of the SI enzyme complexes, and of maltose in the case of the GM enzyme complex, while the hydrogenated condensed Palatinose was cleaved only to a small extent, or virtually not at all, by both enzyme complexes.

### EXAMPLE 5

Metabolism of Hydrogenated Condensed Palatinose by Microorganisms (Human Feces)

Incubating the carbohydrates with human feces allows conclusions to be drawn on the rate of metabolism by the bacterial population and also on the formation of butyrate, which is particularly important as a substrate for colonocytes and is said to have a preventive function with regard to colonic carcinoma.

Besides hydrogenated condensed Palatinose, for comparison, Raftilose® P95 was used as a rapidly fermentable carbohydrate and resistant starch as a slowly fermentable carbohydrate.

The resistant starch used is Novelose 240 (National Starch), whose resistant starch fraction was increased to 83% resistant starch by enzymatic treatment using α-amylase/amyloglucosidase and recovery of the insoluble fraction.

In the case of the hydrogenated condensed Palatinose (Example 2) hydrogenated monosaccharides and disaccharides were separated by gel permeation chromatography. This ensured that the mono-/disaccharides already completely or partially digested in the small intestine are no longer available for metabolism and no longer falsify the result of the in vitro fermentation.

1. In Vitro Fermentation Medium

For the in vitro fermentation experiments the following medium was used:

| | | |
|---|---|---|
| Tryptone | 1.5 | g |
| Yeast extract | 1.0 | g |
| KH₂PO₄ | 0.24 | g |
| Na₂HPO₄ | 0.24 | g |
| (NH₄)₂SO₄ | 1.24 | g |
| NaCl | 0.48 | g |
| MgSO₄ × 7 H₂O | 0.10 | g |
| CaCl₂ × 2 H₂O | 0.06 | g |
| FeSO₄ × 7 H₂O | 2 | mg |
| Resazurin | 1 | mg |
| Cysteine/HCl | 0.5 | ml |
| Vitamin solution (according to DSM 141) | 0.5 | ml |
| Trace element solution (according to DSM 141) | 9.0 | ml |
| NaHCO₃ | 2.0 | g |

| | |
|---|---|
| H₂O, distilled | add 1000 ml, pH 7.0 |

2. Cultivation of Intestinal Bacteria on the Test Oligosaccharides

9 ml of the anaerobic medium described above were admixed with 0.5% (w/v) of the test oligosaccharide and subsequently inoculated with 1 ml of a 10% feces suspension (mixed feces from two volunteers) in anaerobic 50 mM phosphate buffer, pH 7.0, to which 0.5 g/l cysteine/HCl had been added as reducing agent. Hungate tubes were incubated with shaking at 37° C. for 14-48 hours depending on oligosaccharide. Samples were taken at specific points in time and were analyzed for their residual oligosaccharide content, short-chain fatty acid content and lactic acid content, and for their pH.

Result:

% degradation rate for carbohydrates and butyrate content (mmol/l) after in vitro fermentation:

| | |
|---|---|
| | Butyrate |
| | content |
| | (final |
| Hours | sample) |

| | 7 | 14 | 22 | 28 | mmol/l |
|---|---|---|---|---|---|
| Raftilose ® | 100 | — | — | — | 2.5 |
| P95 | | | | | |
| Resistant | 15 | 37 | 66 | 89 | 11.8 |
| starch | | | | | |
| Condensed | 38 | 40 | 89 | 95 | 15.3 |
| Palatinose, | | | | | |
| hydrogenated | | | | | |
| (>DP2) | | | | | |

The fructo-oligosaccharides (Raftilose® P95) were completely metabolized after just 7 hours. Following separation of the mono-/disaccharides, hydrogenated condensed Palatinose (Example 2) was fermented almost completely, at 98%, within 28 hours. The butyrate contents, at 12.8-17.8 mmol/l, were of comparable order both for the resistant starch and for the hydrogenated condensed Palatinose products. Only in the case of the Raftilose® P95 were significantly lower butyrate contents found.

### EXAMPLE 6

Effect of Fermentation Supernatants on GST Activity and Glutathione Content for the Colonic Cell Line HT29

The fermentation mixture obtained for the hydrogenated condensed Palatinose (see Example 5) was worked up as follows to prepare the fermentation supernatant:

1. Centrifugation of 10000×g for 20 minutes at 4° C., 2. sterile filtration with 0.22 μm filter. The solution was stored at −18° C. until use.

The HT29 cells were preincubated for 48 hours. Then the fermentation supernatants (10% by volume) or 10% by volume medium (control) were added. Subsequently the HAT 29 cells were incubated with the fermentation supernatants for a further 72 hours.

Prior to the determination of the glutathione S-transferase activity and the glutathione content, the HAT 29 cells were treated as follows: the cells from the treated incubation batches (approx. 6×10⁶ cells/2.5 ml batch) were suspended in an extraction buffer (20 mM Tris HCl, 250 mM sucrose, 1 mM dithiothreitol, 1 mM PMSF, 1 mM EDTA, pH 7.4) and treated with an Ultra-Turrax for 1 minute.

The total glutathione activity was determined by the method of Habig et al. (J. Biol. Chem. 249, 7130-39, 1974) with 1-chloro-2,4-dinitrobenzene (1 mM).

In the presence of glutathione (1 mM) the reaction took place at 30° C. and a pH 6.5. The conjugate formed was detected by spectrophotometry at 340 nm and was used to calculate the activity. 1 μmol of conjugate per minute corresponds to one activity unit. Intracellular glutathione was determined by means of a colorimetric test (glutathione assay kit, Calbiochem-Novabiochem).

Effect of Fermentation Supernatants of Hydrogenated Condensed Palatinose on Constituents of the Colonic Carcinoma Cell Line HAT 29

| | Glutathione | |
|---|---|---|
| | S-transferases | |
| Fermentation | (nmol/min × 10⁶ | Glutathione |
| supernatants of | cells | (nmol/10⁶ cells) |
| Hydrogenated condensed | 68* | 9.6* |
| Palatinose (>DP2) | | |
| Condensed Palatinose | 45 | 6 |
| (>DP2) | | |
| Resistant starch | 53 | 6 |
| Control | 40 | 6 |
| (without carbohydrate) | | |

*significant

The results say that in the case of the hydrogenated condensed Palatinose both the intracellular glutathione S-transferase activity and the glutathione content are increased relative to the control, by 70% and 60% respectively. The unhydrogenated form of the condensed Palatinose, used for comparison, does not exhibit these significant increases. The same applies to the resistant starch.

### EXAMPLE 7

Determining the Sweetening Power of Hydrogenated Condensed Palatinose

To determine the sweetening power of hydrogenated condensed Palatinose the hydrogenated condensed Palatinose is diluted with drinking water to give a solution with a strength of in each case 18%, 19%, 20%, 21%, 22%, 23%, 24%, 25%, 26%, 27% and 28% and each solution is subsequently passed through a 0.45 μm membrane filter. As a standard for comparison an 8% strength aqueous sucrose solution is prepared.

At the first tasting the samples are handed over in the order indicated above. The testers, 9 persons, are to taste first the comparison standard and subsequently each one of the samples, and are to report whether the sugar standard or the sample is sweeter or whether they can find any difference. Drinking water is used for neutralizing between the tastings.

On the basis of the results of the first tasting it is possible to reduce the number of samples to be tested for the second tasting. The 27% to 20% strength aqueous hydrogenated condensed Palatinose solutions are tasted by 8 testers, beginning with the highest concentration, against the comparison standard, under the conditions described above.

Calculation of Sweetening Power:

Xₗ=changeover point at which there is a change from “standard is sweeter” to “no difference can be found in sweetening power” or from “no difference can be found in sweetening power” to “standard is sweeter”.
Xᵤ=changeover point at which there is a change from “no difference can be found in sweetening power” to “sample is sweeter” or from “sample is sweeter” to “no difference can be found in sweetening power”.

$$lower threshold \text{:} {L}_{1} = \frac{Σ {x}_{1}}{N}$$

$$upper threshold \text{:} {L}_{u} = \frac{Σ {x}_{u}}{N}$$
equivalent stimulus=(Lᵤ+Lₗ)/2
uncertainty range=Lᵤ−Lₗ

$$sweetening power = \frac{sugar concentration}{equivalent stimulus} \cdot 100 \%$$

Result:

As the result from two tastings the sweetening power of the hydrogenated condensed Palatinose of the invention was found to be approximately 34%±2%.

### APPLICATION EXAMPLE 1

### Confectionery

Wine gums

| | Recipe | | | | | | |
|---|---|---|---|---|---|---|---|
| | 1 | 2 | 3 | 4 | 5 | 6 | 7 |
| Gelatin [kg] | 10 | 14 | 11 | 0 | 0 | 20 | 15 |
| Water [kg] | 20 | 26 | 22 | 80 | 90 | 35 | 30 |
| Sugar [kg] | 40 | 35 | 35 | 40 | 50 | 40 | 40 |
| Glucose syrup [kg] | 10 | 10 | 40 | 15 | 10 | 40 | 20 |
| Hydrogenated | 25 | 40 | 55 | 20 | 45 | 40 | 20 |
| condensed | | | | | | | |
| Palatinose [kg] | | | | | | | |
| Fruit acid [kg] | 1.3 | 1.6 | 1.4 | 1.0 | 0.6 | 0.5 | 0.7 |
| Glycerin [kg] | 1.2 | 4 | 0 | 0 | 4.6 | 0 | 0 |
| Gum arabic [kg] | 0 | 0 | 0 | 80 | 84 | 0 | 0 |
| Boiling temperature | 136 | 136 | 123 | 123 | 121 | 123 | 130 |
| [° C.] | | | | | | | |

Soften or dissolve gelatin with water; boil sugar, glucose syrup and hydrogenated condensed Palatinose to the specified temperature, allow to cool a little; add gelatin, fruit acid and glycerin; cast composition, put in hot chamber, carry out powdering and oiling.

Dissolve gum arabic in water overnight and pass through a hairnet; boil sugar, glucose syrup and hydrogenated condensed Palatinose to the specified temperature, allow to cool a little; add the gum solution, glycerin and fruit acid; cast composition, place in hot chamber, carry out powdering and oiling.

Fruit jellies

| | | |
|---|---|---|
| 25 | kg | sugar |
| 25 | kg | hydrogenated condensed Palatinose |
| 0.8 | kg | agar agar |
| 30 | kg | water |
| 11 | kg | apple pulp |
| 0.5 | kg | tartaric acid |
| 0.06 | kg | flavor, essences or color |

Soften agar in water, dissolve, add sugar and further ingredients, and boil to 105° C. Pour the composition into the corresponding molds.

Hard caramels

| Recipe | 1 | 2 |
|---|---|---|
| Hydrogenated condensed Palatinose [g] | 3250 | 1500 |
| Sucrose [g] | — | 1500 |
| Glucose syrup [g] | — | 1500 |
| Water [g] | 968.5 | 200 |
| DL-malic acid [g] | 30 | 30 |
| Flavor [g] | 6 | 6 |
| Color [g] | 3 | 3 |

Recipe 1:

Hydrogenated condensed Palatinose and water are boiled to 160° C. and then evacuated (−0.9 bar). After cooling to 120° C., the predissolved DL-malic acid, flavor and color are stirred in. The melt is embossed or cast.

Recipe 2:

Sucrose, glucose syrup, hydrogenated condensed Palatinose and water are boiled to 135° C. and then evacuated. After cooling to 120° C., the predissolved DL-malic acid, flavor and color are stirred in. The melt is embossed or cast.

Soft caramels

| Recipe | |
|---|---|
| Hydrogenated condensed Palatinose [g] | 164.50 |
| Lycasin 80/55 [g] | 325.00 |
| Water [g] | 32.50 |
| Toffix P [g] | 52.50 |
| Gelatin [g] | 19.50 |
| Monomuls 90-35 [g] | 3.25 |
| Lecithin [g] | 1.30 |
| Calcium carbonate [g] | 50.00 |
| Acesulfame K [g] | 0.33 |
| Aspartame [g] | 0.33 |
| Flavor [g] | 1.3 |

Dissolve hydrogenated condensed Palatinose, Lycasin, sweetener and water; at 120° C. stir in Toffix, lecithin and monomuls; at 125° C. stir in gelatin, calcium carbonate and flavor; carry out molding.

### APPLICATION EXAMPLE 2

### Dog Food

Dog biscuits

| | | |
|---|---|---|
| 150 | g | quark |
| 90 | g | milk |
| 90 | g | edible oil |
| 1 | | egg yolk |
| 75 | g | hydrogenated condensed Palatinose |
| 200 | g | dog flakes |

Mix the ingredients, form small balls and bake at 200° C. for 20 minutes.

Cookies

| | | |
|---|---|---|
| 150 | g | whole grain wheat flour |
| 200 | g | whole grain oat flakes |
| 30 | g | honey |
| 50 | g | hydrogenated condensed Palatinose |
| 5 | g | granulated stock |
| 100 | g | whole egg |
| 150 | g | milk |

Mix the ingredients, form balls and bake at 220° C. for 15 minutes.

### APPLICATION EXAMPLE 3

### Muesli

Muesli bars

| | | |
|---|---|---|
| 200 | g | oat flakes |
| 100 | g | cornflakes |
| 100 | g | hazel nuts |
| 50 | g | sunflower seeds |
| 30 | g | desiccated coconut |
| 75 | g | brown sugar |
| 75 | g | honey |
| 100 | g | hydrogenated condensed Palatinose |
| 50 | g | butter |
| ½ | | lemon |

Caramelize sugar, honey, hydrogenated condensed Palatinose, butter and the juice of half a lemon. Mix oat flakes, corn flakes, nuts, sunflower seeds and desiccated coconut and add. Thoroughly mix the composition and tip onto a baking sheet. Cut out bars and store under dry conditions.

Wintertime fruit muesli

| 4 | tbsp | oat flakes |
|---|---|---|
| 2 | tbsp | millet flakes |
| 1 | tbsp | wheatgerm flakes |
| juice of | | 1 lemon |
| 150 | g | yogurt |
| 1 | tbsp | sea buckthorn |
| 50 | g | chopped nuts |
| 10 | g | raisins |
| 400 | g | apples |
| 200 | g | pears |
| 300 | g | oranges |
| 150 | g | banana |
| 80 | g | hydrogenated condensed Palatinose |

(tbsp = slightly heaped tablespoon)

Mix flakes, yogurt and sea buckthorn, add the nuts. Coarsely grate the apple and finely dice the other fruits, tip lemon juice over the apple and add hydrogenated condensed Palatinose.

Summer muesli

| | | |
|---|---|---|
| 150 | g | apricots, diced |
| 150 | g | low-fat yogurt |
| 40 | g | hydrogenated condensed Palatinose |
| 30 | g | cornflakes |

Breakfast cereals

| | | |
|---|---|---|
| 69.3 | g | wheat flour type 405 |
| 15 | g | oat flour |
| 1 | g | malt, light |
| 2.1 | g | malt, dark |
| 0.6 | g | salt |
| 10 | g | water |
| 12 | g | hydrogenated condensed Palatinose |

Mix wheat flour, oat flour, light and dark malt, hydrogenated condensed Palatinose and salt. The water is added in an extruder. In the extruder the dough is mixed, sheared, boiled, plastified and extruded through annular dies. Subsequently the rings are dried and cooled.

### APPLICATION EXAMPLE 4

### Drinks

Power drink

| | | |
|---|---|---|
| 3 | | oranges |
| 2 | tbsp | wheat germ |
| 35 | g | hydrogenated condensed Palatinose |
| 200 | g | yogurt |

(tbsp = slightly heaped tablespoon)

Squeeze oranges, whisk with wheat germ and hydrogenated condensed Palatinose, and stir in yogurt.

Hobbythek drink

| | | |
|---|---|---|
| 150 | ml | orange juice |
| 50 | ml | mineral water |
| 1 | pinch | HT multivitamin powder |
| 1 | tsp | HT multimineral powder |
| 5 | g | HT apple-wheat fiber |
| 7.5 | g | hydrogenated condensed Palatinose |

(tsp = slightly heaped teaspoon)

[Hobbythek is a German consumer affairs TV program which has given rise among other things to certain “mix your own” ingredients for consumer products, labeled ‘HT’ in some of the recipes here]

Driver 1

| | | |
|---|---|---|
| 200 | ml | rosehip tea |
| 100 | ml | grape juice |
| 5 | g | HT apple-wheat fiber |
| 1 | tsp | honey |
| 5 | g | hydrogenated condensed Palatinose |

(tsp = slightly heaped teaspoon)

Driver 2

| | | |
|---|---|---|
| 300 | ml | rosehip tea |
| 5 | g | HT apple-wheat fiber |
| 1 | tbsp | quark |
| 100 | ml | grape juice |
| 10 | g | hydrogenated condensed Palatinose |

(tbsp = slightly heaped tablespoon)

Aronia-apple fiber drink

| | | |
|---|---|---|
| 200 | ml | mineral water |
| 1½ | tsp | aronia fruit syrup |
| 1 | tsp | apple fruit syrup |
| 2 | tsp | HT apple fiber |
| 10 | g | hydrogenated condensed Palatinose |

(tsp = slightly heaped teaspoon)

Sportspersons' cocktail

| | | |
|---|---|---|
| 2 | | tomatoes |
| ½ | | cucumber |
| 250 | g | carrots |
| 250 | g | apples |
| 4 | tbsp | cream |
| | | parsley |
| 50 | g | hydrogenated condensed Palatinose |

(tbsp = slightly heaped tablespoon)

Juice tomatoes, cucumber, carrots and apples, and add cream, parsley and condensed Palatinose.

Tomato cocktail

| 6 | | tomatoes |
|---|---|---|
| 4 | tbsp | cream |
| juice of | | 1 orange |
| 1 | pinch | salt |
| 7.5 | g | hydrogenated condensed Palatinose |
| 1 | pinch | paprika |
| 2 | squirts | Tabasco |

(tbsp = approx. 12 ml)

Puree tomatoes and stir together with remaining ingredients.

Orange nectar containing 50% fruit:

| | | |
|---|---|---|
| 120 | kg | orange nectar base 50:11; juice content 400%; |
| | | extract content 50% |
| 48 | kg | sugar syrup 65% solids |
| 60 | kg | hydrogenated condensed Palatinose |
| 820 | kg | drinking water |

Lemonade

| | | |
|---|---|---|
| 4.5 | kg | lemonade base 3:100; extract content 40% |
| 60 | kg | sugar syrup 65% solids |
| 75 | kg | hydrogenated condensed Palatinose |
| 888.5 | kg | drinking water |
| 8 | kg | CO₂ |

Application Example 5: Fruit preparations
Red fruit jelly

| | | |
|---|---|---|
| 330 | g | sour cherries |
| 150 | g | blueberries |
| 300 | g | raspberries |
| 300 | g | strawberries |
| 60 | g | starch |
| 1 | l | fruit juice |
| 60 | g | sugar |
| 50 | g | hydrogenated condensed Palatinose |

Stir up the starch with a little cold fruit juice and stir into the boiling fruit juice. Leave to boil for 5 minutes. Add the fruits, the sugar and the hydrogenated condensed Palatinose.

Cold rhubarb soup

| 750 | g | rhubarb |
|---|---|---|
| ½ | l | water |
| juice of | | ½ lemon |
| 120 | g | sugar |
| 75 | g | hydrogenated condensed Palatinose |
| 0.2 | l | white wine |

Wash rhubarb, cut, steam with water and the lemon juice until soft. While still warm, stir together with sugar and hydrogenated condensed Palatinose, leave to cool, and stir in white wine.

Fruit puree

| | | |
|---|---|---|
| 750 | g | fruits |
| 30 | g | fruit juice |
| 50 | g | hydrogenated condensed Palatinose |
| 3 | ml | rum |

Puree the ingredients in a mixer.

Strawberry cream

| | | |
|---|---|---|
| 375 | g | strawberries |
| 50 | g | hydrogenated condensed Palatinose |
| 1 | small pack | vanilla sugar |
| 2 | sheets | gelatin white |
| 2 | sheets | gelatin red |
| 250 | ml | cream |

Puree berries, add hydrogenated condensed Palatinose and vanilla sugar, add dissolved gelatin, and cool. Whip the cream until stiff and fold in.

Apricot cream

| | | |
|---|---|---|
| 100 | g | apricots |
| 375 | ml | water |
| 30 | g | sugar |
| 50 | g | hydrogenated condensed Palatinose |
| 1 | pack | vanilla sugar |
| 4 | sheets | white gelatin |
| 1 | sheet | red gelatin |
| 250 | ml | cream |

Boil apricots, water, sugar, hydrogenated condensed Palatinose and vanilla sugar for 30 minutes. Dissolve gelatin in apricot compote, puree composition, and cool. Beat cream until stiff and fold in.

### APPLICATION EXAMPLE 6

### Yogurt

Lemon yogurt shake

| 600 | g | low fat yogurt |
|---|---|---|
| juice of | | 4 lemons |
| 4 | tsp | honey |
| 30 | g | hydrogenated condensed Palatinose |
| 4 | | egg yolks |

Mix ingredients.

Lemon yogurt cream

| | | |
|---|---|---|
| 4 | | eggs |
| 40 | g | sugar |
| 40 | g | hydrogenated condensed Palatinose |
| 25 | ml | lemon juice |
| 300 | g | yogurt |
| 6 | g | gelatin powder |

Soften the gelatin. Separate yolks from whites. Mix yogurt, yolk, sugar, hydrogenated condensed Palatinose and lemon juice. Dissolve the gelatin and add. Beat the egg white to a foam and fold in.

### APPLICATION EXAMPLE 7

### Jams

Südzucker preserving sugar recipes

| | | PS 1 |
|---|---|---|
| | PS 1 | plus 1 |
| Recipe | plus 1 | fructose |
| Pectin [g] | 7.370 | 7.370 |
| Citric acid [g] | 10.700 | 10.700 |
| Hydrogenated condensed | 490.965 | 490.965 |
| Palatinose [g] | | |
| Sugar [g] | 490.965 | 0.000 |
| Fructose [g] | 0.000 | 490.965 |
| Fruit [g] | 970.000 | 970.000 |

| | PS 2 | | PS 3 |
|---|---|---|---|
| Recipe | plus 1 | PSwS | plus 1 |
| Amidated pectin [g] | 6.41 | 8.00 | 11.55 |
| Citric acid [g] | 3.80 | 3.80 | 3.80 |
| Sorbic acid [g] | 0.63 | 0.63 | 0.63 |
| Hydrogenated condensed | 489.17 | 110.00 | 484.02 |
| Palatinose [g] | | | |
| Sugar [g] | 0.00 | 377.57 | 0.00 |
| Fruit [g] | 970.00 | 1000.00 | 1455.00 |

Boiling time 4 minutes in each case (except for PSwS)
PSwS: boiling time 5 minutes

Sour cherry jam with amaretto and vanilla

| | | |
|---|---|---|
| 1 | kg | sour cherries |
| 3 | | vanilla pods |
| 500 | g | preserving sugar 2:1 |
| 40 | ml | amaretto (almond liqueur) |

Thoroughly comminute half of the sour cherries in a mixer. Mix the pureed fruit with the remainder of the cherries, the pulp of the vanilla pods and the preserving sugar, and bring to the boil with stirring. Leave to bubble at the boil for 4 minutes. Add the amaretto. Introduce the jam into glass jars while still hot, and seal immediately.

Rhubarb and strawberry jam

| | | |
|---|---|---|
| 750 | g | rhubarb |
| 250 | g | strawberries |
| 1000 | g | preserving sugar 1:1 |
| 3 | small packs | vanilla sugar |
| 1 | tbsp | finely chopped lemon balm |

Cut rhubarb and strawberries into pieces. Mix the fruits with preserving sugar and vanilla sugar and leave covered for 3 to 4 hours to steep. The bring to the boil with stirring and boil at the bubble for 4 minutes. Stir in the lemon balm. Introduce the jam into glass jars while still hot, and seal immediately.

Pumpkin jelly

| 1.5 | kg | pumpkin |
|---|---|---|
| 1.2 | l | water |
| 1 | kg | preserving sugar 1:1 |
| juice of | | 2 lemons |
| 1 | tsp | chopped mint |

Cut the pumpkin into cubes and boil with the water for 20 to 30 minutes until soft. Pass the juice through a cloth. Mix 750 ml of cold juice with preserving sugar and lemon juice and bring to the boil with stirring. Leave boiling at the bubble for 4 minutes. Stir in the mint. Introduce the jelly into glass jars while still hot, and seal immediately.

Strawberry jam with Grand Marnier

| | | |
|---|---|---|
| 1 | kg | strawberries |
| 1 | kg | preserving sugar |
| 1 | | untreated orange |
| 65 | g | Grand Marnier (orange liqueur) |

Crush the strawberries, add preserving sugar and the grated peel of the orange, and mix all ingredients thoroughly. Bring to the boil with stirring and leave stirring at the bubble for 4 minutes. Stir in Grand Marnier. Introduce into glass jars while still hot, and seal immediately.

### APPLICATION EXAMPLE 8

### Bakery Products

Yeast is used as raising agent in the recipes listed. The capacity of baker's yeast to use the hydrogenated condensed Palatinose of the invention as a substrate is limited. Therefore only some of the sugar is replaced by hydrogenated condensed Palatinose.

Croissant

| Component | |
|---|---|
| Yeast [g] | 25 |
| Cream [g] | 250 |
| Sugar [g] | 25 |
| Hydrogenated condensed Palatinose [g] | 35 |
| Wheat flour type 550 [g] | 400 |
| Salt [g] | 0.15 |
| Margarine [g] | 200 |
| Egg yolk [g] | 50 |

Stir together yeast, lukewarm cream, 1 pinch of salt and 1 pinch of flour. Leave to prove for 10 minutes. Knead with other ingredients and leave to prove for 20 minutes. Knead dough thoroughly, roll out, cut out 15 triangles and roll up to croissants. Leave to rise briefly and bake at 200° C. for 10 minutes.

White bread

| Component | |
|---|---|
| Yeast [g] | 40 |
| Sugar [g] | 15 |
| Hydrogenated condensed Palatinose [g] | 20 |
| Wheat flour type 550 [g] | 1000 |
| Milk [g] | 500 |
| Margarine [g] | 250 |
| Grated lemon rind [g] | 2.5 |
| Whole egg [g] | 50 |

Stir yeast with sugar into lukewarm milk and leave to prove for 10 minutes. Knead with the other ingredients and leave to prove for 20 minutes. Bake in a loaf tin at 175° C. for 45 minutes.

Sesame bread

| Component | |
|---|---|
| Yeast [g] | 60 |
| Milk [g] | 500 |
| Sugar [g] | 30 |
| Hydrogenated condensed Palatinose [g] | 45 |
| Wheat flour type 550 [g] | 300 |
| Rye flour type 1150 [g] | 250 |
| Wheat meal type 1700 [g] | 200 |
| Salt [g] | 0.15 |
| Margarine [g] | 100 |
| Sesame seed [g] | 100 |

For preparation see White bread

Basic recipe for short pastry

| | | Short pastry |
|---|---|---|
| | | without |
| Component | Short pastry | sugar |
| Flour [g] | 250 | 250 |
| Sugar [g] | 35 | 0 |
| Hydrogenated condensed Palatinose [g] | 45 | 90 |
| Salt [g] | 0.15 | 0.15 |
| Chilled margarine [g] | 125 | 125 |
| Whole egg [g] | 50 | 50 |

Briefly mix all ingredients with kneading hook at lowest setting and then knead thoroughly at a higher setting. Chill dough before baking.

Basic recipe for sponge mixture

| | | Sponge |
|---|---|---|
| | | mixture |
| | Sponge | without |
| Component | mixture | sugar |
| Margarine [g] | 125 | 125 |
| Sugar [g] | 65 | 0 |
| Hydrogenated condensed Palatinose [g] | 90 | 180 |
| Salt [g] | 0.15 | 0.15 |
| Whole egg [g] | 100 | 100 |
| Flour [g] | 250 | 250 |
| Baking powder [g] | 8 | 8 |
| Milk [g] | 125 | 125 |

Stir all ingredients with the whisk first on a low setting, then at the highest setting. The two sponge mixtures thus prepared go browner than a sponge mixture with sugar, and are less sweet. It is therefore recommended that the two sponge mixtures set out above be sweetened with a sweetener if required.

Basic fatless sponge recipe

| | | Fatless |
|---|---|---|
| | | sponge |
| | Fatless | without |
| Component | mixture | sugar |
| Whole egg [g] | 200 | 200 |
| Water [g] | 60 | 60 |
| Sugar [g] | 65 | 0 |
| hydrogenated condensed Palatinose [g] | 90 | 180 |
| Flour [g] | 75 | 75 |
| Corn starch [g] | 75 | 75 |
| Baking powder | 0.5 | 0.5 |

Beat egg yolk, water, sugar, hydrogenated condensed Palatinose and salt to a foam with the whisk. Add very stiffly beaten egg white to the egg yolk mixture. Mix flour, corn starch and baking powder, sieve onto the foamy mixture, and fold in carefully.

1. A process for preparing hydrogenated condensed Palatinose, comprising the catalytic hydrogenation of a solution comprising condensed Palatinose.

2. The process of claim 1, wherein the condensed Palatinose is obtained by heat-treating an aqueous Palatinose solution having a pH of 3 to 6 at a temperature of 100° C. to 170° C. under atmospheric pressure or reduced pressure.

3. The process of claim 2, wherein the aqueous Palatinose solution to be condensed is prepared by dissolving Palatinose in water.

4. The process of claim 2, wherein acidic catalysts are added to the aqueous Palatinose solution.

5. The process of claim 4, wherein the acidic catalysts are selected from the group consisting of H⁺-loaded, strongly acidic cation exchangers, organic acids, boric acid, and a combination of phosphoric acid with potassium dihydrogen phosphate or ammonium sulfate.

6. The process of claim 5, wherein the organic acids are selected from the group consisting of citric acid, malic acid, succinic acid and tartaric acid.

7. The process of claim 2, wherein the condensed Palatinose is obtained by heat-treating an aqueous Palatinose solution in the presence of 0.02% by weight citric acid, based on Palatinose, in vacuo at a temperature of 135° C.

8. The process of claim 7, wherein the condensed Palatinose comprises about 48% uncondensed Palatinose, about 28% Palatinose dimers, about 12% Palatinose trimers, about 5% Palatinose tetramers, about 5% Palatinose pentamers, and about 2% hydrolysis products.

9. The process of claim 1, comprising hydrogenating condensed Palatinose obtained by reacting Palatinose with anhydrous hydrofluoric acid at a temperature of 0° C. to 20° C.

10. The process of claim 9, wherein the condensed Palatinose comprises about 73% to 94% Palatinose dimers.

11. The process of claim 1, comprising hydrogenating condensed Palatinose obtained from a Palatinose melt by adding Palatinose to a solution of a catalytically active, acidic substance in water to form a mixture and heating the mixture at a temperature of 130° C. to 160° C.

12. The process of claim 11, wherein the mixture comprises 4% to 12% by weight water and 0.05% to 0.5% by weight acidic substance.

13. The process of claim 11, wherein the acidic substance is selected from the group consisting of an H⁺-loaded, strongly acidic cation exchanger, an organic acid, boric acid, and a combination of phosphoric acid with potassium dihydrogen phosphate or ammonium sulfate.

14. The process of claim 13, wherein the organic acid is citric acid.

15. The process of claim 11, wherein the condensed Palatinose comprises 15% to 45% by weight uncondensed Palatinose, 35% to 60% by weight Palatinose dimers, less than 10% by weight Palatinose trimers, and less than 5% by weight Palatinose tetramers and Palatinose pentamers.

16. The process of claim 15, wherein the fraction of uncondensed Palatinose in the condensed Palatinose is reduced by depletion.

17. The process of claim 16, wherein the uncondensed Palatinose is depleted by chromatographic separation of the uncondensed Palatinose from condensed Palatinose.

18. The process of claim 1, wherein the catalytic hydrogenation of the solution comprising condensed Palatinose takes place at elevated temperature under elevated pressure in the presence of hydrogen and using a catalyst.

19. The process of claim 18, wherein the solution comprising condensed Palatinose is adjusted to a pH of 6 to 8 prior to hydrogenation.

20. The process of claim 19, wherein the pH of the solution comprising condensed Palatinose is adjusted to 7.8 by adding aqueous sodium hydroxide solution.

21. The process of claim 18, wherein the hydrogenation takes place at a temperature of 40° C. to 140° C.

22. The process of claim 21, wherein the hydrogenation takes place at a temperature of 60° C. to 80° C.

23. The process of claim 22, wherein the hydrogenation takes place at a temperature of 70° C.

24. The process of claim 18, wherein the hydrogenation takes place at a pressure of 50 to 230 bar.

25. The process of claim 24, wherein the pressure is 100 to 200 bar.

26. The process of claim 25, wherein the pressure is 150 bar.

27. The process of claim 18, wherein the catalyst comprises a mixture of a pure Raney metal and a Raney metal alloy.

28. The process of claim 27, wherein the Raney metal is nickel, copper, cobalt or iron.

29. The process of claim 27, wherein the Raney metal alloy is an alloy of nickel, copper, cobalt or iron with a material selected from the group consisting of aluminum, tin and silicon.

30. The process of claim 18, wherein the catalyst comprises as an active component one or more metals from transition group VIII of the periodic table on a support.

31. The process of claim 30, wherein the active component comprises at least one of ruthenium, palladium and rhodium.

32. The process of claim 30, wherein the catalyst support comprises at least one of activated carbon, aluminum oxide, zirconium oxide and titanium dioxide.

33. The process of claim 18, wherein the hydrogenation takes place with stirring.

34. The process of claim 18, wherein the hydrogenation takes place over a period of at least 2 to 5 hours.

35. The process of claim 34, wherein the hydrogenation takes place over a period of at least 4 hours.

36. The process of claim 18, wherein the hydrogenation takes place continuously, semibatchwise or batchwise.

37. The process of claim 18, wherein the hydrogenation is carried out in a fixed-bed process or a suspension process.

38. The process of claim 1, wherein, following hydrogenation of the solution comprising condensed Palatinose, a product mixture is obtained that comprises 25% to 36% by weight hydrogenated condensed Palatinose having a DP of 4, 9% to 15% by weight hydrogenated condensed Palatinose having a DP of 6, 3% to 7% by weight hydrogenated condensed Palatinose having a DP of 8, 3% to 7% by weight hydrogenated condensed Palatinose having a DP of 10, 3% to 7% by weight unhydrogenated condensed Palatinose, and 40% to 55% by weight hydrogenated uncondensed Palatinose.

39. The process of claim 1, wherein, following hydrogenation, hydrogenated condensed Palatinose having a DP of 4 to 10 is separated from the reaction mixture.

40. The process of claim 39, wherein said hydrogenated condensed Palatinose having a DP of 4 to 10 is separated from the reaction mixture by chromatography.

41. The process of claim 39, wherein the hydrogenated condensed Palatinose, following separation from the reaction mixture, comprises 30% to 55% by weight hydrogenated condensed Palatinose having a DP of 4, 20% to 30% by weight hydrogenated condensed Palatinose having a DP of 6, 7% to 13% by weight hydrogenated condensed Palatinose having a DP of 8, and 2% to 6% by weight hydrogenated condensed Palatinose having a DP of 10.

42. A hydrogenated condensed Palatinose obtained by hydrogenating condensed Palatinose according to the process of claim 1, said hydrogenated condensed Palatinose comprising at least hydrogenated condensed Palatinose having a DP of 4, hydrogenated condensed Palatinose having a DP of 6, hydrogenated condensed Palatinose having a DP of 8, and hydrogenated condensed Palatinose having a DP of 10.

43. The hydrogenated condensed Palatinose of claim 42, comprising at least one compound of the formula (1) 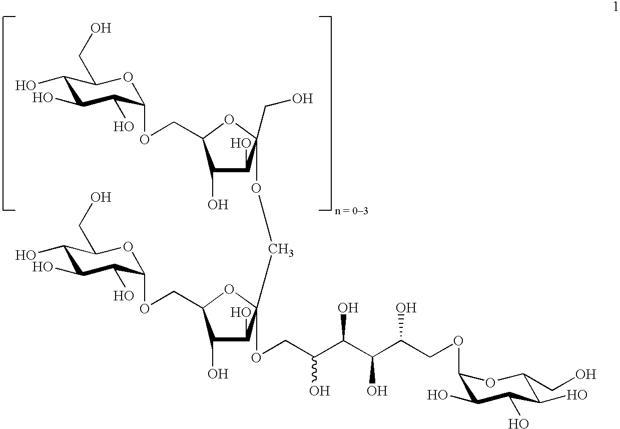
obtained from α-2→1-linked di-Palatinose, for n=0 (DP 4):
O-α-D-glucopyranosyl-(1→6)-α-D-fructofuranosyl-(2→1)-O-[α-D-glucopyranosyl-(1→6)]-D-sorbitol and
O-α-D-glucopyranosyl-(1→6)-α-D-fructofuranosyl-(2→1)-O-[α-D-glucopyranosyl-(1→6)]-D-mannitol;
at least one compound of the formula (2) 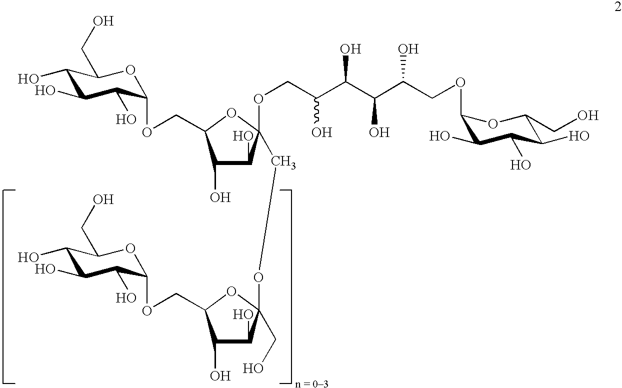
obtained from β-2→1-linked di-Palatinose for n=0 (DP 4):
O-α-D-glucopyranosyl-(1→6)-β-D-fructofuranosyl-(2→1)-O-[α-D-glucopyranosyl-(1→6)]-D-sorbitol and
O-α-D-glucopyranosyl-(1→6)-β-D-fructofuranosyl-(2→1)-O-[α-D-glucopyranosyl-(1→6)]-D-mannitol;
at least one compound of the formula (3) 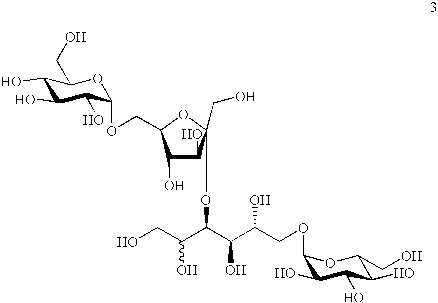
obtained from α-2→3-linked di-Palatinose:
O-α-D-glucopyranosyl-(1→6)-α-D-fructofuranosyl-(2→3)-O-[α-D-glucopyranosyl-(1→6)]-D-sorbitol and
O-α-D-glucopyranosyl-(1→6)-α-D-fructofuranosyl-(2→4)-O-[α-D-glucopyranosyl-(1→1)]-D-mannitol;
at least one compound of the formula (4) 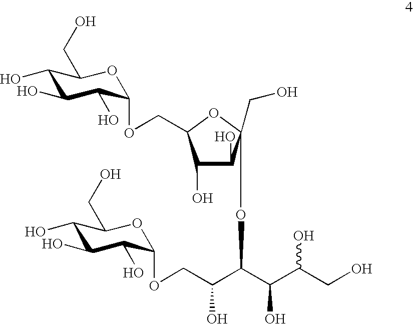
obtained from α-2→4-linked di-Palatinose:
O-α-D-glucopyranosyl-(1→6)-α-D-fructofuranosyl-(2→4)-O-[α-D-glucopyranosyl-(1→6)]-D-sorbitol and
O-α-D-glucopyranosyl-(1→6)-α-D-fructofuranosyl-(2→3)-O-[α-D-glucopyranosyl-(1→1)]-D-mannitol;
at least one compound of the formula (5) 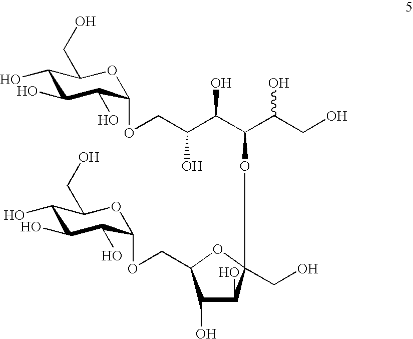
obtained from β-2→3-linked di-Palatinose:
O-α-D-glucopyranosyl-(1→6)-β-D-fructofuranosyl-(2→3)-O-[α-D-glucopyranosyl-(1→6)]-D-sorbitol and
O-α-D-glucopyranosyl-(1→6)-β-D-fructofuranosyl-(2→4)-O-[α-D-glucopyranosyl-(1→1)]-D-mannitol; and
and at least one compound of the formula (6) 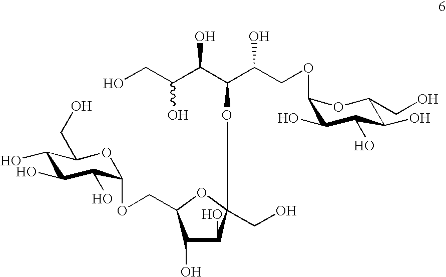
obtained from β-2→4-linked di-Palatinose:
O-α-D-glucopyranosyl-(1→6)-β-D-fructofuranosyl-(2→4)-O-[α-D-glucopyranosyl-(1→6)]-D-sorbitol and
O-α-D-glucopyranosyl-(1→6)-β-D-fructofuranosyl-(2→3)-O-[α-D-glucopyranosyl-(1→1)]-D-mannitol.

44. The hydrogenated condensed Palatinose of claim 42, wherein the fraction of hydrogenated condensed Palatinose having a DP of 4 is 30% to 55% by weight, the fraction of hydrogenated condensed Palatinose having a DP of 6 is 20% to 30% by weight, the fraction of hydrogenated condensed Palatinose having a DP of 8 is 7% to 13% by weight, and the fraction of hydrogenated condensed Palatinose having a DP of 10 is 2% to 6% by weight.

45. The hydrogenated condensed Palatinose of claim 42, wherein the fraction of hydrogenated condensed Palatinose having a DP of 4 is 35% to 50% by weight.

46. The hydrogenated condensed Palatinose of claim 42, wherein the fraction of hydrogenated condensed Palatinose having a DP of 6 is 22% to 28% by weight.

47. The hydrogenated condensed Palatinose of claim 42, wherein the fraction of hydrogenated condensed Palatinose having a DP of 8 is 8% to 12% by weight.

48. The hydrogenated condensed Palatinose of claim 42, wherein the fraction of hydrogenated condensed Palatinose having a DP of 10 is 3% to 5% by weight.

49. The hydrogenated condensed Palatinose of claim 42, further comprising 6% to 12% by weight unhydrogenated condensed Palatinose having a DP of 4.

50. The hydrogenated condensed Palatinose of claim 42, which is at least substantially resistant to breakdown in at least one of a mammalian stomach and a mammalian digestive tract.

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. A composition comprising the hydrogenated condensed Palatinose of claim 42 and cultures of Bifidobacteria.

67. A composition comprising the hydrogenated condensed Palatinose of claim 42 and at least one further form of fiber selected from the group consisting of short-chain fructo-oligosaccharides, long-chain fructo-oligosaccharides, galacto-oligosaccharides, hydrolyzed guar gum, lactulose, xylo-oligosaccharides, lactosucrose, malto-oligosaccharides, isomalto-oligosaccharides, gentio-oligosaccharides, glucosyl sucrose, soybean oligosaccharides, chito-oligosaccharides, chitosan oligosaccharides, resistant starch, oat fiber, wheat fiber, vegetable fiber, fruit fiber, celluloses, and sugar beet fiber.

68. A foodstuff comprising the hydrogenated condensed Palatinose of claim 42.

69. The foodstuff of claim 68, wherein the foodstuff is selected from the group consisting of dairy products and milk products.

70. The foodstuff of claim 69, wherein said dairy products and milk products are selected from the group consisting of cheese, butter, yogurt, kefir, quark, sour milk, buttermilk, cream, condensed milk, dry milk, whey, lactose, milk protein, milk mixture, half-fat milk, whey mixture, and milk fat products.

71. The foodstuff of claim 68, wherein the food stuff comprises bakery products.

72. The foodstuff of claim 71, wherein said bakery products are selected from the group consisting of bread, including cookies, and fine bakery products, including nonperishable bakery products.

73. The foodstuff of claim 68, wherein the foodstuff comprises a spread for bread.

74. The foodstuff of claim 68, wherein the foodstuff comprises at least one of margarine products and cooking fats.

75. The foodstuff of claim 68, wherein the foodstuff comprises at least one of instant products and stock products.

76. The foodstuff of claim 68, wherein the foodstuff comprises a fruit product.

77. The foodstuff of claim 76, wherein the foodstuff comprises at least one of marmalades, jams, jellies, fruit conserves, fruit pulps, fruit juices, fruit juice concentrates, fruit nectar, and fruit powders.

78. The foodstuff of claim 68, wherein the foodstuff comprises a vegetable product.

79. The foodstuff of claim 78, wherein the foodstuff comprises at least one of vegetable conserves, vegetable juices, and vegetable pulp.

80. The foodstuff of claim 68, wherein the foodstuff comprises a spice mixture.

81. The foodstuff of claim 68, wherein the foodstuff comprises at least one of nonalcoholic beverages, beverage base materials, and beverage powders.

82. The foodstuff of claim 68, which is a reduced-calorie foodstuff.

83. A confectionery product comprising the hydrogenated condensed Palatinose of claim 42.

84. The confectionery product of claim 83, wherein said product is selected from the group consisting of chocolate, hard caramels, soft caramels, fondant products, jelly products, licorices, marshmallow products, desiccated coconut, coated chocolate candies, compressed candy products, candied fruits, cracknel, nougat products, ice confections, marzipan, chewing gum, muesli bars, ice cream and alcoholic and nonalcoholic sweet drinks.

85. The confectionery product of claim 83, wherein said product comprises a reduced-calorie confectionery product.

86. A dietetic specialty food particularly useful for the nutrition of persons having glucose intolerance, comprising hydrogenated condensed Palatinose of claim 42.

87. An infant food, comprising the hydrogenated condensed Palatinose of claim 42.

88. A sweetener comprising the hydrogenated condensed Palatinose of claim 42.

89. A pharmaceutical composition comprising the hydrogenated condensed Palatinose of claim 42.

90. The pharmaceutical composition of claim 89, comprising hydrogenated condensed Palatinose as an active substance.

91. The pharmaceutical composition of claim 89, comprising hydrogenated condensed Palatinose as a pharmaceutical carrier.

92. A method for preventing or treating a disease caused due to oxidative stress, said method comprising administering to a subject in need thereof a therapeutically effective amount of the hydrogenated condensed Palatinose of claim 42.

93. The method of claim 92, wherein the disease is selected from the group consisting of cancer, diabetes I and II, hypertension, stroke, male infertility, rheumatic illnesses, coronary artery illnesses, acute myocardial infarction and chronic inflammatory diseases.

94. A method for strengthening the immune system of a subject against infection, said method comprising administering to a subject in need of such strengthening a therapeutically effective amount of the hydrogenated condensed Palatinose of claim 42.

95. The method of claim 92, wherein the hydrogenated condensed Palatinose is administered in the form of a pharmaceutical composition.

96. The method of claim 95, wherein said pharmaceutical composition is in a form selected from the group consisting of a suspension, a syrup, a tablet, a pill, a capsule, granules and a powder.

97. The method of claim 94, wherein the hydrogenated condensed Palatinose is administered in the form of a pharmaceutical composition.

98. The method of claim 97, wherein said pharmaceutical composition is in a form selected from the group consisting of a suspension, a syrup, a tablet, a pill, a capsule, granules, and a powder.

99. A method for forming a pharmaceutical carrier for a pharmaceutical composition, wherein the method comprises including in said pharmaceutical carrier an effective amount of the hydrogenated condensed Palatinose of claim 42.

100. A method for forming a pharmaceutical composition for preventing or treating a disease caused by oxidative stress, wherein the method comprising incorporating into the pharmaceutical composition a sufficient amount of the hydrogenated condensed Palatinose of claim 42 to prevent or treat said disease in a subject in need thereof.

101. A method for forming a pharmaceutical composition for strengthening the immune system of a subject against infection, wherein the method comprises incorporating into the pharmaceutical composition a sufficient amount of the hydrogenated condensed Palatinose of claim 42 to strengthen the immune system of a subject in need thereof.

102. A method for preparing a foodstuff or a drink intended for human consumption which comprises adding to the foodstuff or drink an amount of the hydrogenated condensed Palatinose of claim 42 effective to produce a desired result.

103. The method of claim 102, wherein said hydrogenated condensed Palatinose is added to the foodstuff or drink as a soluble fiber.

104. The method of claim 103, wherein said fiber is a prebiotic fiber.

105. A method for modulating the glycemic properties of foodstuffs or confectionery products, wherein the method comprises adding to the foodstuff or confectionery product an amount of the hydrogenated condensed Palatinose of claim 42 effective to modulate the glycemic properties thereof.

106. A method for producing a sweetening composition which comprises incorporating into the composition an effective amount of the hydrogenated condensed Palatinose of claim 42.

107. A method for preparing a foodstuff or a confectionery, which comprises incorporating into the foodstuff or confectionery the hydrogenated condensed Palatinose of claim 42.

108. The method of claim 107, wherein the foodstuff is an acidic foodstuff having a pH of 2 to 5.

109. The method of claim 108 wherein the pH is 2 to 4.

110. A method for preparing fruit juice or a fruit preparation which comprises incorporating into the juice or preparation the hydrogenated condensed Palatinose of claim 42.
